(19) United States
(12) Patent Application Publication
(10) Pub. No.: US 2007/0147782 A1
(43) Pub. Date: Jun. 28, 2007

(54) Information reproducing apparatus and method of displaying the status of the information reproducing apparatus

(76) Inventor: Makoto Shibata, Tachikawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/643,882

(22) Filed: Dec. 22, 2006

(30) Foreign Application Priority Data
Dec. 22, 2005 (JP) 2005-370750

(51) Int. Cl. H04N 7/00

(52) U.S. Cl. 386/95

(57) ABSTRACT

When an object is reproduced according to a playlist, the reproducing status is lively displayed. An information reproducing apparatus includes a navigation manager which manages a playlist used to arbitrarily specify reproducing times of a plurality of objects in a singular form and/or multiplexed from, a data access manager, a data cache which temporarily stores the fetched object according to the playlist and outputs the same, a presentation engine used as a decoder, an AV renderer, a live information analyzer, and a status display data storage section which outputs object identification information of the object now output according to the analyzing result.

### CROSS-REFERENCE TO RELATED APPLICATIONS

This application is based upon and claims the benefit of priority from Japanese Patent Application No. 2005-370750, filed Dec. 22, 2005, the entire contents of which are incorporated herein by reference.

### BACKGROUND

1. Field

One embodiment of the invention relates to an information reproducing apparatus and a reproducing status display method and more particularly to an apparatus which can deal with a plurality of display objects reproduced from a disk, fetch information from the Internet and a memory connected thereto and output the information to a display section.

2. Description of the Related Art

Recently, Digital Versatile Disks (DVDs) and reproducing apparatuses thereof are widely used.

And High Definition or High Density DVDs (HD DVDs) on which information can be recorded with high density or high image quality and reproducing apparatuses thereof are developed.

In the DVD, since the information storage capacity is increased to 4.7 Gbytes, a plurality of video streams (for example, multi-angle streams) can be recorded. In the reproducing apparatus, a design is made to display an angle mark so that the user can get information as to what stream (angle) among a plurality of video streams is now reproduced (for example, Japanese Patent Document 1: No. 2003-87746). Therefore, the user can recognize the angle which the reproducing apparatus reproduces and recognize that the angles can be switched. Thus, the reproducing apparatus has a function of presenting the reproducing status with respect to the user and enhances the recognizability of the reproducing status when the user operates the reproducing apparatus and watches video pictures.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B show the configuration of standard content and that of advanced content, respectively;

FIGS. 2A, 2B, and 2C are explanatory diagrams of a category-1 disc, category-2 disc, and category-3 disc, respectively;

FIG. 3 is a diagram to help explain an example of reference to enhanced video objects (EVOB) on the basis of time map information (TMAPI);

FIG. 4 is a diagram to help explain an example of the transition of the disc reproducing state;

FIG. 5 is a diagram to help explain a volume space of a disc related to the present invention;

FIG. 6 is a diagram to help explain an example of directories and files of a disc related to the present invention;

FIG. 7 is a diagram to help explain the configuration of management information (VMG) and a video title set (VTS) according to the present invention;

FIG. 8 is a flowchart for a start-up sequence of a player model related to the present invention;

FIG. 9 is a diagram to help explain a pack mixed state of primary EVOB-TY2 related to the present invention;

FIG. 10 is a diagram to help explain an advanced content player according to the invention and its peripheral environment;

FIG. 11 shows a model of the advanced content player of FIG. 10;

FIG. 12 is a diagram to help explain the concept of recording information on a disc related to the present invention;

FIG. 13 shows an example of the configuration of directories and files of a disc related to the present invention;

FIG. 14 is a more detailed explanatory diagram of the model of the advanced content player;

FIG. 15 is a diagram to help explain an example of the video mixing model of FIG. 14;

FIG. 16 is a diagram to help explain an example of a graphic hierarchy according to the present invention;

FIG. 17 is an explanatory diagram showing the state in which objects are processed based on object mapping of a playlist;

FIGS. 18A and 18B are explanatory diagrams showing an example in which the type of the present reproducing object is displayed on a display device;

FIG. 19 is an explanatory diagram showing an example in which the type of the present reproducing object is displayed on a display of the apparatus main body;

FIG. 20 is a diagram to help explain an audio mixing model according to the present invention;

FIG. 21 is a diagram to help explain a disc data supply model according to the present invention;

FIG. 22 is a diagram to help explain a network and a persistent storage data supply model according to the present invention;

FIG. 23 is a diagram to help explain a data storage model according to the present invention;

FIG. 24 is a diagram to help explain a user input processing model according to the present invention;

FIG. 25 is a diagram to help explain the working of a playlist in the operation of the apparatus related to the present invention;

FIG. 26 is a diagram to help explain a state where objects are mapped on the timeline according to the playlist in the operation of the apparatus related to the present invention;

FIG. 27 is a diagram to help explain the relationship of reference between the playlist file and other objects in the present invention;

FIG. 28 is a diagram to help explain a playback sequence in the apparatus related to the present invention;

FIG. 29 is a diagram to help explain an example of playback in a trick play in the apparatus related to the present invention;

FIG. 30 is a diagram to help explain an example of the content of an advanced application related to the present invention;

FIG. 31 is a flowchart for an advanced content start-up sequence in the operation of the apparatus related to the present invention;

FIG. 32 is a flowchart for an advanced content playback update sequence in the operation of the apparatus related to the present invention;

FIG. 33 is a flowchart for a sequence of conversion between advanced VTS and standard VTS in the operation of the apparatus related to the present invention;

FIG. 34 is a diagram to help explain the content of information recorded on a disc-like information recording medium according to an embodiment of the present invention;

FIGS. 35A and 35B are diagrams to help explain an example of the configuration of advanced content;

FIG. 36 shows an example of the configuration of a playlist;

FIG. 37 is a diagram to help explain an example of the allocation of presentation objects on the timeline;

FIG. 38 is a diagram to help explain a case where a trick play (such as chapter jump) of representation objects is performed on the timeline;

FIG. 39 is a diagram to help explain an example of the configuration of a playlist when an object includes angle information;

FIG. 40 is a diagram to help explain an example of the configuration of a playlist when an object includes a multi-story;

FIG. 41 is a diagram to help explain an example of the description of object mapping information in the playlist;

FIG. 42 is a diagram to help explain an example of the description of object mapping information in the playlist; and

FIG. 43 is a diagram to help explain examples of advanced object types (showing three examples).

### DETAILED DESCRIPTION

Various embodiments according to the invention will be described hereinafter with reference to the accompanying drawings.

In one embodiment of this invention, there are provided an information reproducing apparatus and a reproducing status display method which can display the live reproducing status to be easily understood by the user when the reproducing sequence is changed according to a playlist and combinations of multiple reproducing processes are variously made and a plurality of objects which are subjected to an independent reproducing process or multiple reproducing process are reproduced.

In the present embodiment, the information reproducing apparatus includes a navigation manager 113 which manages a playlist used to arbitrarily specify reproducing time of a plurality of independent objects in a singular form and/or multiplexed form, a data access manager 111 which fetches the object corresponding to the reproducing time from an information source at time precedent to the reproducing time specified by the playlist, a data cache 112 which temporarily stores a singular object or a plurality of objects fetched by the data access manager according to the order of the reproducing times specified by the playlist and outputs the same in an order corresponding to the reproducing time, a presentation engine 115 which decodes a singular object or a plurality of objects output from the data cache by use of a corresponding decoder, an AV renderer 116 which outputs a singular object or a plurality of objects output from the presentation engine and decoded in a singular form or in a combined form, a live information analyzer 121 which analyzes the type of the singular object or the plurality of objects output according to the playlist by the data access manager and data cache, and a status display data storage section 122 which outputs object identification information corresponding to the object now output according to the analyzing result of the live information analyzer.

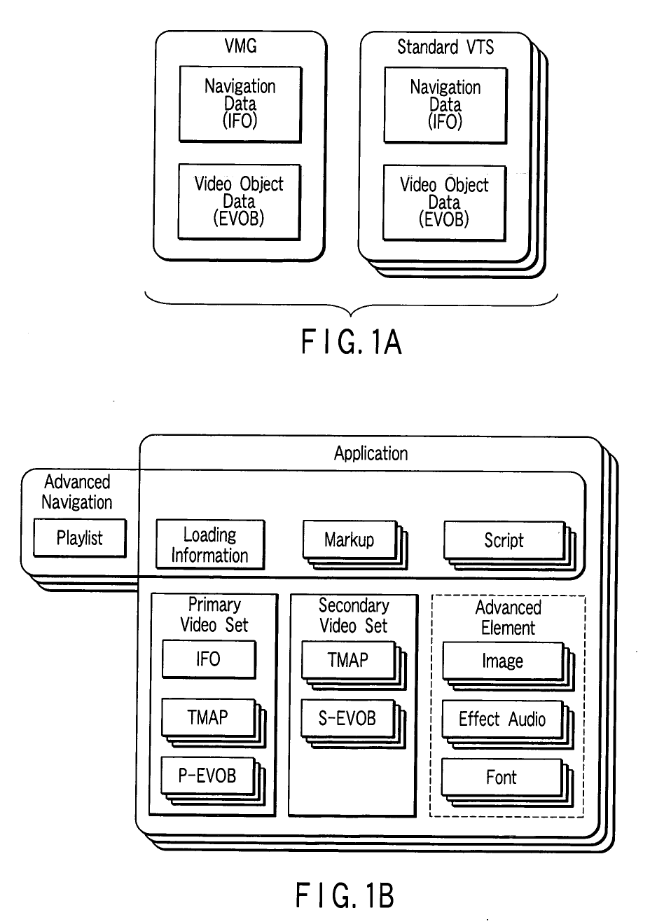

Hereinafter, referring to the accompanying drawings, an embodiment of the present invention will be explained. FIG. 1 is a block diagram showing the basic concept of the present invention. In an information recording medium, an information transmission medium, an information processing method and apparatus, an information reproducing method and apparatus, and an information recording method and apparatus according to the present invention, new effective improvements have been made in the data format and the data format handling method. Accordingly, of the resources, video data, audio data, and program data are particularly reusable. Moreover, the flexibility in combining a plurality of resources and changing the combination of resources is increased. This will become clear from the configuration, function, and operation of each section explained below.

<Introduction>

The types of content will be explained.

In the explanation below, two types of content are determined. One is standard content and the other is advanced contenttandard content, which is composed of video objects on a disc and navigation data, is an extension of DVD-video standard version 1.1.

Advanced content is composed of advanced navigation data, including playlist, loading information, markup, script files, advanced data, including primary/secondary video set, and advanced elements (including images, audio, and text).

It is necessary to position at least one playlist file and at least one primary video set on a disc. The other data may be placed on the disc or taken in from a server.

<Standard Content>(see FIG. 1A)

Standard content is an extension of the content determined in DVD-video standard version 1.1, particularly high-resolution video, high-quality audio, and several new functions. Standard content is basically composed of one VMG space and one or more VTS spaces (referred to as “standard VTS” or simply as “VTS”).

<Advanced Content>(see FIG. 1B)

Advanced content realizes higher interactivity in addition to an extension of audio and video realized in standard content. Advanced content is composed of advanced navigation data, including playlist, loading information, markup, script files, advanced data, including primary/secondary video set, and advanced elements (including images, audio, and text). The advanced navigation manages the reproduction of advanced data.

When a playlist described in XML is on the disc and advanced content is on the disc, the player executes the file first. The file provides the following information:
Object Mapping Information: Information in the title for presentation objects mapped on a title timeline.
Playback Sequence: Playback information for each title written on the title timeline.
Configuration Information: System configuration information, such as data buffer alignment.

When the first application includes primary/secondary video sets according to the description of the playlist, the file is executed referring to these. One application is composed of loading information, markup (including content style/timing information), script, and advanced data. The first markup file, script file, and other resources constituting the application are referred to in one loading information file. With the markup, the reproduction of advanced data, including the primary/secondary video sets, and advanced elements is started.

A primary video set is composed of one VTS space used exclusively for the content. That is, the VTS has neither a navigation command nor a multilayer structure, but has TMAP information. The VTS can hold one main video stream, one sub-video stream, eight main audio streams, and eight sub-audio streams. This VTS is called “advanced VTS.”

A secondary video set is used in adding video/audio data to a primary video set and also used in adding only audio data. The data can be reproduced only when a video/audio stream in the primary video set has not been reproduced, and vice versa.

A secondary video set is recorded on a disc or taken in from a server in the form of one file or a plurality of files. When data has been recorded on the disc and it is necessary to reproduce the data together with the primary video set simultaneously, the file is stored temporarily in a file cache before reproduction. On the other hand, when the secondary video set is on a website, it is necessary to store all of the data temporarily in a file cache (“downloading”) or store part of the data continuously into a streaming buffer. The stored data is reproduced simultaneously with no buffer overflow, while the data is being downloaded from the server (streaming). FIG. 1(B) shows an example of the configuration of advanced content.
Description of Advanced Video Title Set (Advanced VTS)

Advanced VTS (also referred to as a primary video set) is used in a video title set for advanced navigation. That is, the following are determined to be items corresponding to the standard VTS:

1) Further enhancement of EVOB
One main video stream, one sub-video stream
Eight main video streams, eight sub-video streams
32 sub-picture streams
One advanced stream

2) Integration of enhanced EVOB sets (EVOBS)
Integration of menu EVOBS and title EVOBS

3) Dissolution of multilayer structure
No title, no PGC (program chain), no PTT (part-of-title), no cell
Cancellation of navigation commands and UOP (user operation) control

4) Introduction of new time map information (TMAP)
One TMAPI corresponds to one EVOB and is stored as one file.
Part of the information in NV-PCK is simplified.
Description of interoperable VTS

Interoperable VTS is a video title set supported in the HD DVD-VR standard. In the present standard, that is, in the HD DVD-video standard, interoperable VTS is not supported and therefore the writer of the content cannot form a disc including interoperable VTS. However, a HD DVD-video player supports the reproduction of interoperable VTS.

<Disc Type>

In the present standard, three types of discs (category-1 disc/category-2 disc/category-3 disc) determined below are permitted.
Description of category-1 disc

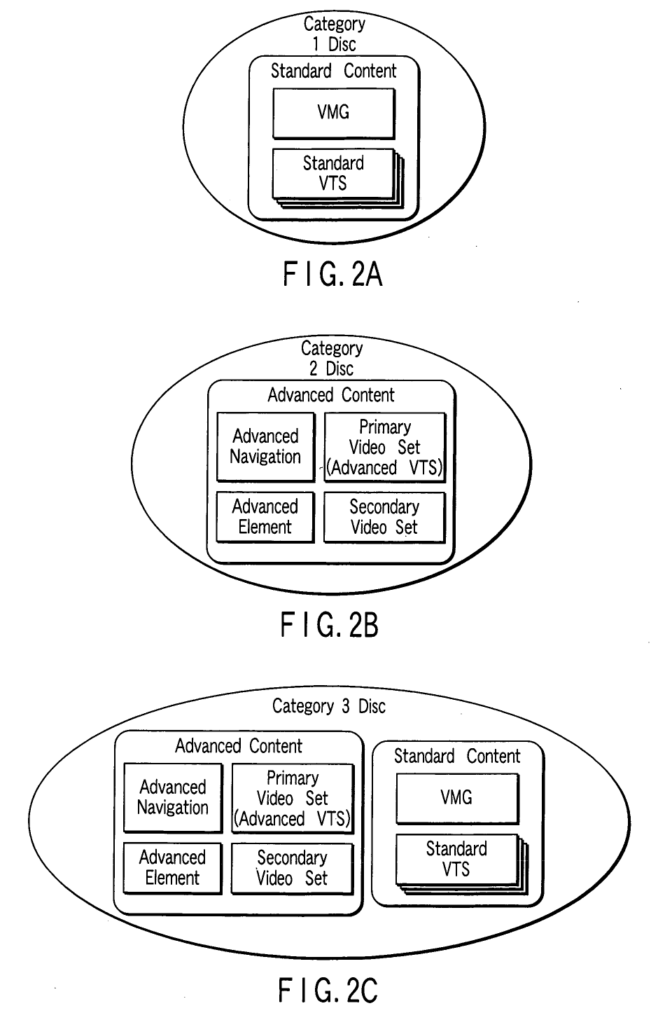

This disc includes only a standard content composed of one VMG and one or more standard VTSs. That is, this disc includes neither advanced VTS nor advanced content. Refer to FIG. 2A for an example of the configuration.
Description of category-2 disc

This disc includes only advanced content composed of advanced navigation, a primary video set (advanced VTS), a secondary video set, and an advanced element. That is, this disc does not include a standard contentuch as VMG or standard VTS. Refer to FIG. 2B for an example of the configuration.
Description of category-3 disc

This disc includes only advanced content composed of advanced navigation, a primary video set (advanced VTS), a secondary video set, and an advanced element, and a standard content composed of VMG (video manager) and one or more standard VTSs. Here, the VMG includes neither PF_DOM nor VMGM_DOM. Refer to FIG. 2C for an example of the configuration.

Although the disc includes standard content, it basically follows the category-2 disc rule. The disc further includes the transition from the advanced content playback state to the standard content playback state and the transition from the latter to the former.
Description of use of standard content by advanced content

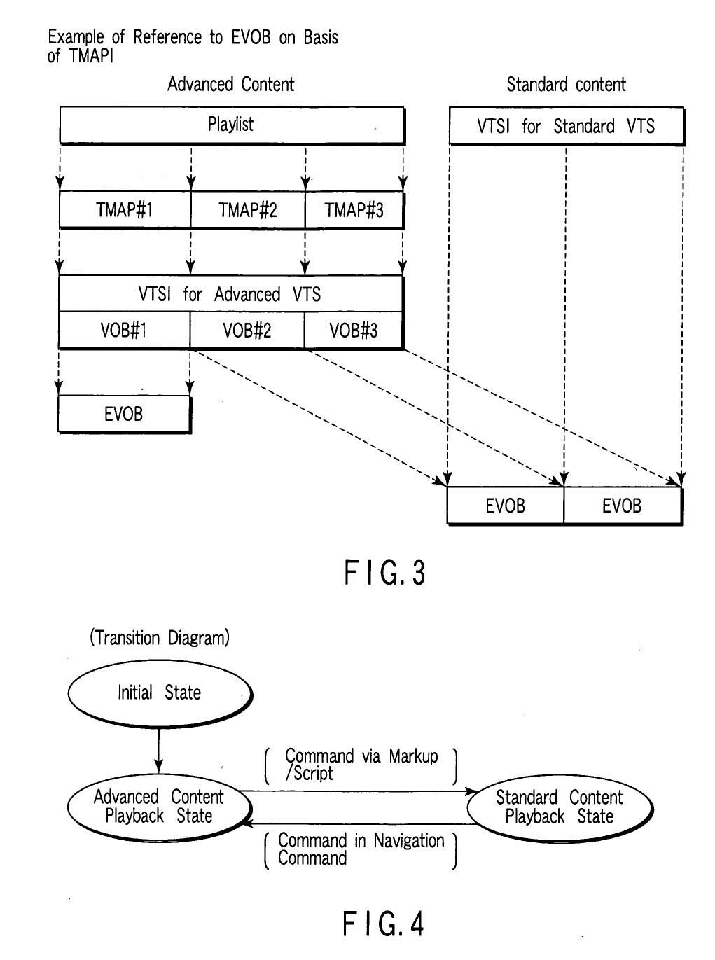

Advanced content can use standard content. VTSI (video title set information) in the advanced VTS can refer to EVOB. Using TMAP, EVOB can also be referred to by VTSI in the standard VTS. Here, HLI (highlight information), PCI (program control information), and the like can be included in EVOB, which is not supported in the advanced content. In the reproduction of such EVOB, for example, HLI and PCI are ignored in the advanced content. FIG. 3 shows the way the standard content is used as described above.
Description of the transition between the playback state of standard content and that of advanced content

As for a category-3 disc, the advanced content and standard content are reproduced independently. FIG. 4 shows a transition diagram of the disc playback state. First, the advanced navigation (or playlist file) is interpreted in the initial state. According to the file, the first application in the advanced content is executed in an advanced content playback state. In this case, while the advanced content is being reproduced, the player executes a specified command, such as CallStandardContentPlayer, together with an argument specifying a playback position via a script, which enables the standard content to be reproduced.

Furthermore, while the standard content is being reproduced, the player executes a specified command, such as CallAdvancedContentPlayer, a navigation command, thereby returning to the advanced content playback state.

In the advanced content playback state, the advanced content can read and set system parameters (SPRM(1) to SPRM(10)). During the transition, the values of SPRM are held consecutively. For example, in the advanced content playback state, the advanced contentets SPRM for an audio stream according to the present audio playback state for suitable audio stream playback in the standard content playback state after the transition. Even if the user in the standard content playback state changes the audio stream, the advanced content reads SPRM for an audio stream after the transition, thereby changing the audio playback state in the advanced content playback state.

<Logical Data Structure>

The structure of a disc is composed of a volume space, a video manager (VMG), a video title set (VTS), an enhanced video object set (EVOBS), and advanced content.

<Structure of Volume Space>

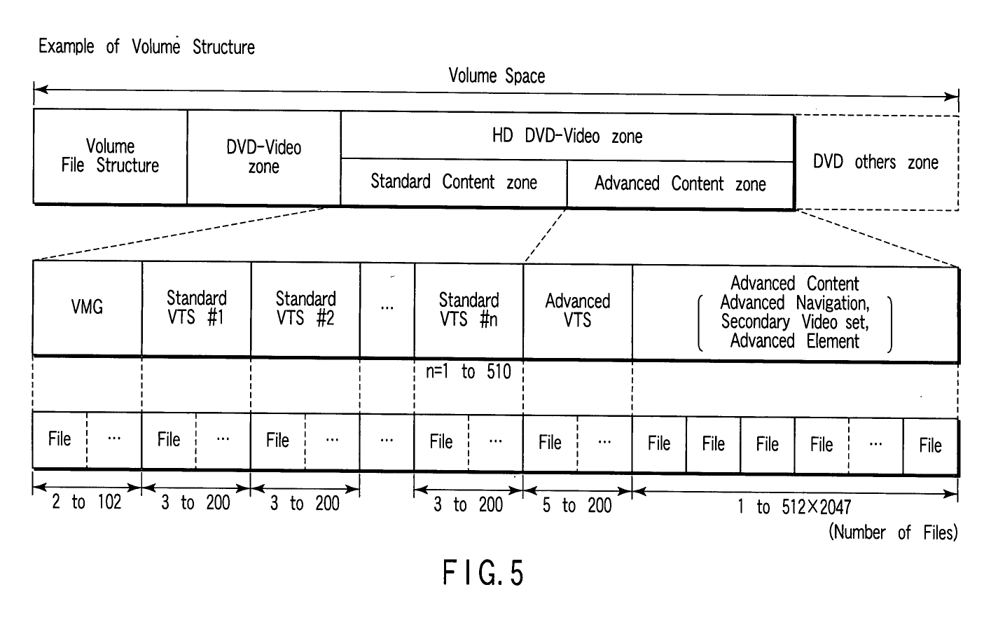

As shown in FIG. 5, a volume space of an HD DVD-video disc is composed of the following elements:

1) Volume and file structure. This is allocated to a UDF structure.

b 2) A single DVD-video zone. This may be allocated to a DVD-video format data structure.

3) A single HD DVD-video zone. This may be allocated to a DVD-video format data structure. This zone is composed of a standard content zone and an advanced content zone.

4) A zone for DVD and others. This may be used for neither DVD-video application nor HD DVD-video application.

The following rules are applied to an HD DVD-video zone:

1) An HD DVD-video zone is composed-of a standard content zone in a category-1 disc. An HD DVD-video zone is composed of an advanced content zone in a category-2 disc. An HD DVD-video zone is composed of a standard content zone and an advanced content zone in a category-3 disc.

2) A standard content zone is composed of a video manager (VMG) and at least one or a maximum of 510 video title sets (VTS) in a category-1 disc. A standard content zone must not be present in a category-2 disc. A standard content zone is composed of at least one or a maximum of 510 video title sets (VTS) in a category-3 disc.

3) When there is an HD DVD-video zone, that is, in a category-1 disc, VMG is allocated to its beginning part.

4) VMG is composed of at least two or a maximum of 102 files.

5) Each VTS (excluding advance VTS) is composed of at least three or a maximum 200 files.

6) An advanced content zone is composed of files supported in an advanced content zone having advanced VTS. The maximum number of files for an advanced content zone is 512×2047 (under ADV_OBJ directory).

7) An advanced VTS is composed of at least five and at rent 200 files.

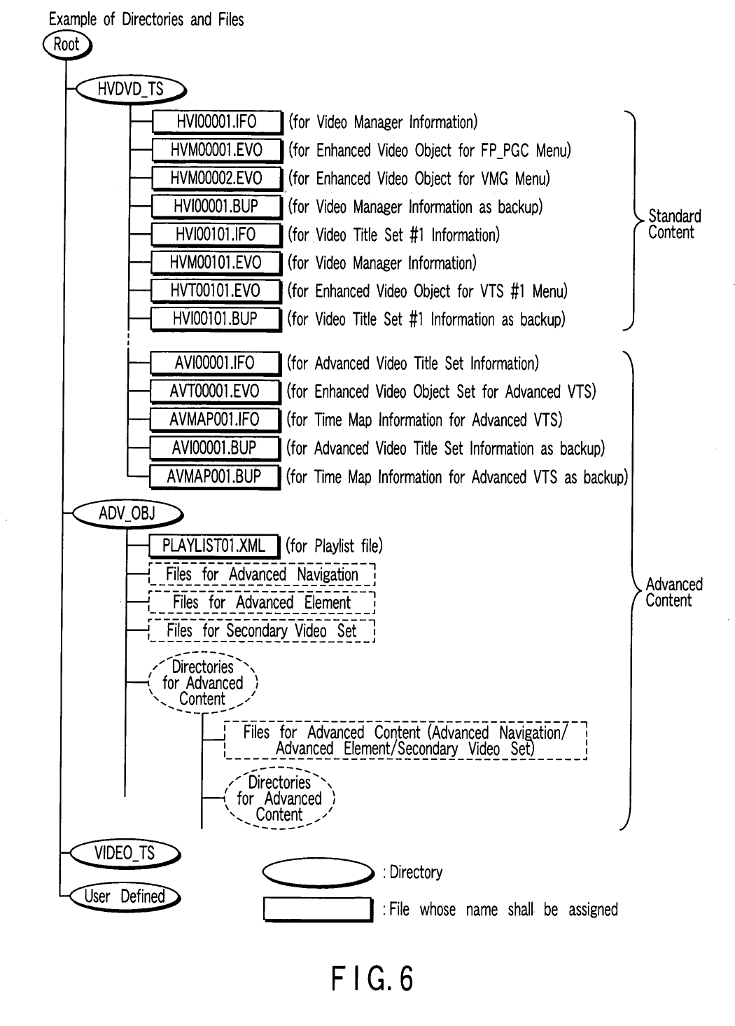

Note: since DVD-video zones are well known, explanation of them will be omitted.

<Rules for directories and files (FIG. 6)>

The requirements for files and directories related to an HD DVD-video disc will be described below.

HVDVD_TS Directory

An HDDVD_TS directory is just under the root directory. All files related to one VMG, one or more standard video sets, and one advanced VTS (primary video set) are under this directory.

Video Manager (VMG)

Each of a piece of video manager information (VMGI), a first play program chain menu enhanced video object (FP_PGCM_EVOB), and a piece of backup video manager information (VMGI_BUP) is recorded as a component file under the HVDVD_TS directory. When the size of a video manager menu enhanced video object set (VMGM_EVOBS) is 1 GB (=230 bytes) or more, it is necessary to divide the set so that the number of files may be a maximum of 98 under the HVDVD_TS directory. All of the files in a VMGM_EVOBS have to be allocated consecutively.

Standard Video Title Set (Standard VTS)

Each of a piece of video title set information (VTSI) and a piece of backup video title set information (VTSI_BUP) is recorded as a component file under the HVDVD_TS directory. When the size of a video title set menu enhanced video object set (VTSM_EVOBS) and that of a title enhanced video object (VTSTT_VOBS) are 1 GB (=230 bytes) or more, it is necessary to divide the set so that the number of files may be a maximum of 99 in such a manner that the size of any file is smaller than 1 GB. These files are component files under the HVDVD_TS directory. All of the files in each of a VTSM_EVOBS and a VTSTT_EVOBS have to be allocated consecutively.

Advanced Video Title Set (Advanced VTS)

Each of a piece of video title set information (VTSI) and a piece of backup video title set information (VTSI_BUP) is recorded as a component file under the HVDVD_TS directory. Each of a piece of video title set time map information (VTS_TMAP) and a piece of backup video title set time map information (VTS_TMAP_BUP) can be composed of a maximum of 99 files under the HVDVD_TS directory. When the size of a title enhanced video object set (VTSTT_VOBS) is 1 GB (=230 bytes) or more, it is necessary to divide the set so that the number of files may be a maximum of 99 in such a manner that the size of any file is smaller than 1 GB. These files are component files under the HVDVD_TS directory. All of the files in a VTSTT_EVOBS have to be allocated consecutively.

The following rules are applied to the file names and directories under the HVDVD_TS directory:

1) Directory Name

Let the fixed directory name of DVD-video be HVDVD_TS.

2) Video Manage (VMG) File Name

Let the fixed file name of video manager information be HVI00001.IFO.

Let the fixed file name of FP_PGC menu enhanced video object be HVM00001.EV0.

Let the file name of a menu enhanced video object set be HVM000%%.EV0.

Let the fixed file name of backup video manager information be HVI0001.BUP.
“%%” in the range from 02 to 99 are allocated consecutively in ascending order to the individual enhanced video object sets for VMG menu.

3) Standard Video Tile Set (Standard VTS) File Name

Let the file name of a video title set be HVI@@@01.IF0.

Let the file name of a VTS menu enhanced video object set be HVM@@@##.EVO.

Let the file name of a title enhanced video object set be HVT@@@##.EVO.

Let the file name of backup video title set information be HVI@@@01.BUP.
“@@@” are three characters allocated to files with video title set numbers. Suppose “@@@” is in the range from 001 to 511.
“##” in the range from 01 to 99 are allocated consecutively in ascending order to the individual enhanced video object sets for VTS menu or to individual enhanced video object sets for titles.

4) Advanced Video Title Set (Advanced VTS) File Name

Let the file name of a video title set be AVI00001.IF0.

Let the file name of a title enhanced video object set be AVT000&&.EV0.

Let the file name of time map information be AVMAP0$$.IF0.

Let the file name of backup video title set information be AVI00001.BUP.

Let the file name of backup time map information be AVMAP0$$.BUP.
“&&” in the range from 01 to 99 are allocated consecutively in ascending order to title enhanced object sets.
“$$” in the range from 01 to 99 are allocated consecutively in ascending order to time map information.

ADV_OBJ Directory

ADV_OBJ directory is just under the root directly. All of the playlist files are just under the directory. Any of an advanced navigation file, an advanced element file, and a second video set file can be placed just under the directory.

Playlist

Each playlist file can be placed just under the ADV_OBJ directory by the file name “PLAYLIST%%.XML.” “%%” in the range from 00 to 99 are allocated consecutively in ascending order. The playlist file with the largest number is processed first (when the disc is loaded).

Advanced Content Directory

An advanced content directory can be placed only under the ADV_OBJ directory. Any of an advanced navigation file, an advanced element file, and a secondary video set file can be placed under this directory. The directory name is composed of d characters and dl characters. Let the total number of ADV_OBJ sub-directories (excluding ADV_OBJ directories) be less than 512. Let the depth of the directory hierarchy be 8 or less.

Advanced Content File

The total number of files under the ADV_OBJ directory is limited to 512×2047. Let the total number of files in each directory be less than 2048. The file name is composed of d characters or d1 characters. The file name is made up of the body, “.” (dot), and an extension. FIG. 6 shows an example of the above-described directory/file structure.

<Structure of Video Manager (VMG)>

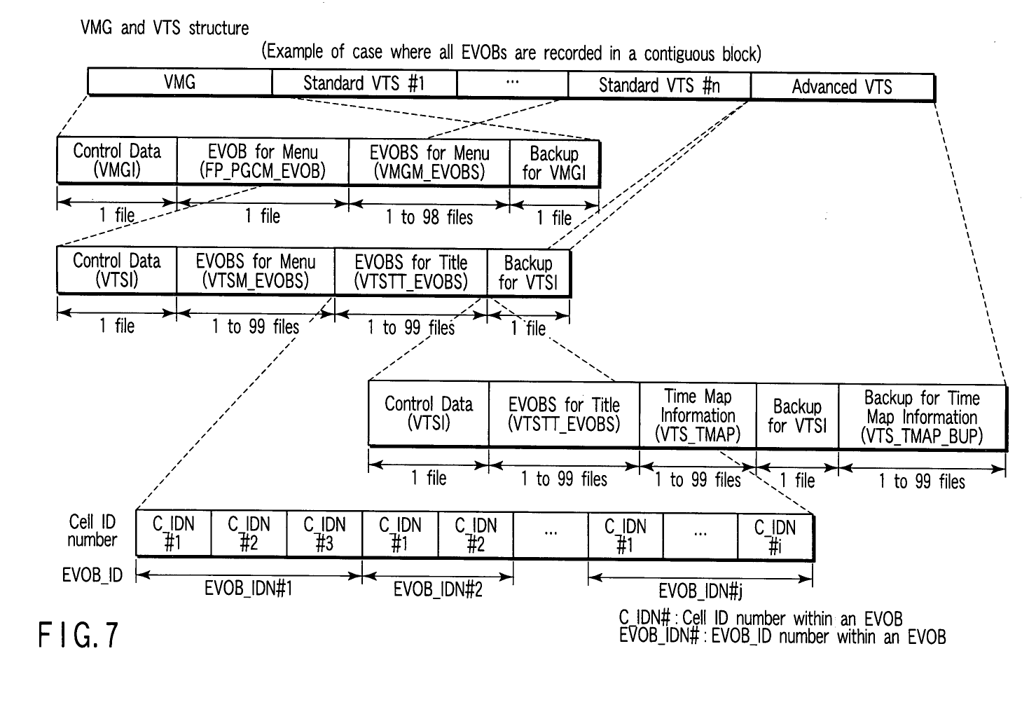

VMG is a table of content of all the video title sets in the HD DVD-video zone. As shown in FIG. 7, VMG is composed of control data called VMGI (video manager information), a first play PGC menu enhanced video object (FP_PGCM_EVOB), a BMG menu enhanced video object set (VMGM_EVOBS), and control data backup (VMGI_BUP). The control data is static information necessary to reproduce titles and provides information to support user operations. FP_PGCM_EVOB is an enhanced video object (EVOB) used to select a menu language. VMGM_EVOB is a set of enhanced video objects (EVOB) used in a menu to support volume access.

The following rules are applied to the video manager (VMG):

1) Let each of control data (VMGI) and control data backup (VMGI_BUP) be stored in a single file with less than 1 GB.

2) Let FP_PGC menu EVOB (FP_PGCM_EVOB) be a single file with less than 1 GB. Divide BMG menu EVOBS (VMGM_EVOBS) into files each with less than 1 GB in such a manner that the maximum number of files is 98.

3) VMGI, FP_PGCM_EVOB (if present), VMGM_EVOBS (if present), and VMGI_BUP are allocated in that order.

4) Do not record VMGI and VMGI_BUP in the same ECC block.

5) The files constituting VMGM_EVOBS are allocated consecutively.

6) Let the content of VMGI_BUP be identical with those of VMGI. Accordingly, when relative address information in VMGI_BUP indicates a place outside VMGI_BUP, the relative address is regarded as the relative address of VMGI.

7) There may be a gap at the boundary between VMGI, FP_PGCM_EVOB (if present), VMGM_EVOBS (if present), and VMGI_JBUP.

8) In VMGM_EVOBS (if present), the individual EVOBs are allocated consecutively.

9) Each of VMGI and VMGI_BUP is recorded into a logically continuous area composed of consecutive LSNs.

Note: Although this standard is applicable to DVD-R for General (general purposes)/DVD-RAM/DVD-RW, and DVD-ROM, it must conform to the rules for data allocation written in Part 2 (of File System Specifications) for each medium.

<Structure of Standard Video Title Set (Standard VTGS)>

VTS is a set of titles. As shown in FIG. 7, each VTS is composed of control data called VTSI (video title set information), a VTS menu enhanced video object set (VTSM_EVOBS), a title enhanced video object set (VTSTT_EVOBS), and backup control data (VTSI_BUP).

The following rules are applied to a video title set (VTS):

1) Let each of control data (VTSI) and control data backup (VTSI_BUP) be stored in a single file with less than 1 GB.

2) Divide each of VTS menu EVOBS (VTSM_EVOBS) and EVOBS in one VTS (VTSTT_EVOBS) into files each with less than 1 GB in such a manner that the maximum number of files is 99.

3) VTSI, VTSM_EVOB (if present), VTSTT_EVOBS, and VTSI_BUP are allocated in that order.

4) Don't record VTSI and VTSI_BUP in the same ECC block.

5) The files constituting VTSM_EVOBS are allocated consecutively. In addition, the files constituting VTSTT_EVOBS are also allocated consecutively.

6) Let the content of VTSI_BUP be identical with those of VTSI. Accordingly, when relative address information in VTSI_BUP indicates a place outside VTSI_BUP, the relative address is regarded as a relative address of VTSI.

7) VTS numbers are consecutive numbers allocated to the VTSs in a volume. VTS numbers, which range from 1 to 511, are allocated in the order in which VTSs are stored on a disc (beginning with the smallest LBN at the head of VTSI in each VTS).

8) There may be a gap at the boundary between VTSI, VTSM_EVOB (if present), VTSTT_EVOBS, and VTSI_BUP in each VTS.

9) In each VTSM_EVOBS (if present), the individual EVOBs are allocated consecutively.

10) In each VTSTT_EVOBS, the individual EVOBs are allocated consecutively.

11) Each of VTSI and VTSI_BUP is recorded into a logically continuous area composed of consecutive LSNs.

Note: Although this standard is applicable to DVD-R for General (general purposes)/DVD-RAM/DVD-RW, and DVD-ROM, it must conform to the rules for data allocation written in Part 2 (of File System Specifications) for each medium. The details of allocation are described in Part 2 (of File System Specifications) for each medium.

<Structure of Advanced Video Title Set (Advanced VTS)>

This VTS is composed of only one title. As shown in FIG. 7, the VTS is composed of control data called VTSI (refer to 6.3.1 Video Title Set Information), a title enhanced video object set in a VTS (VTSTT_EVOBS), video title set time map information (VTS_TMAP), backup control data (VTSI_BUP), and backup of video title set time map information (VTS_TMAP_BUP).

The following rules are applied to a video title set (VTS):

1) Let each of control data (VTSI) and control data backup (VTSI_BUP) (if present) be stored in a single file with less than 1 GB.

2) Divide title EVOBS in a VTS (VTSTT_EVOBS) into files each with less than 1 GB in such a manner that the maximum number of files is 99.

Divide each of a piece of video title set time map information (VTS_TMAP) and its backup (VTS_TMAP_BUP) (if present) into files each with less than 1 GB in such a manner that the maximum number of files is 99.

4) Do not record VTSI and VTSI BUP (if present) in the same ECC block.

5) Do not record VTS_TMAP and VTS_TMAP_BUP (if present) in the same ECC block.

6) The files constituting VTSTT_EVOBS are allocated consecutively.

7) Let the content of VTSI_BUP (if present) be identical with those of VTSI. Accordingly, when relative address information in VTSI_BUP indicates a place outside VTSI_BUP, the relative address is regarded as the relative address of VTSI.

8) In each VTSTT_EVOBS, the individual EVOBs are allocated consecutively.

Note: Although this standard is applicable to DVD-R for General (general purposes)/DVD-RAM/DVD-RW, and DVD-ROM, it must conform to the rules for data allocation written in Part 2 (of File System Specifications) for each medium. The details of allocation are described in Part 2 (of File System Specifications) for each medium.

<Structure of Enhanced Video Object Set (EVOBS)>

EVOBS is a set of enhanced video objects composed of video, audio, sub-picture, and the like (FIG. 7).

The following rules are applied to EVOBS:

1) In an EVOBS, EVOB is recorded in consecutive blocks and interleaved blocks. For consecutive blocks and interleaved blocks, refer to 3.3.12.1 Allocation of Presentation Data.

In the case of VMG and standard VTS,

2) An EVOBS is composed of one or more EVOBS. EVOB_ID numbers are allocated in ascending order, beginning with EVOB having the smallest LSN in the EVOBS, that is, (1).

3) An EVOB is composed of one or more cells. C_ID numbers are allocated in ascending order, beginning with a cell having the smallest LSN in the EVOB, that is, (1).

4) A cell in the EVOBS can be identified by EVOB_ID number and C_ID number.

2.3.7 Relationship between Logical Sructure and Physical structure

The following rules are applied to cells for VMG and standard VTS.

One cell is allocated to the same layer.

<MIME Type>

The extension name and MIME type of each resource in the standard are defined in Table 1. Table 1 shows file extensions and MIME types.

TABLE 1
File Extension and MIME Type

| Extension | Content | MIME Type |
|---|---|---|
| XML, xml | Playlist | text/hddvd+xml |
| XML, xml | Manifest | text/hddvd+xml |
| XML, xml | Markup | text/hddvd+xml |
| XML, xml | Timing Sheet | text/hddvd+xml |
| XML, xml | Advanced Subtitle | text/hddvd+xml |

[System Model]

<Overall Startup Sequence>

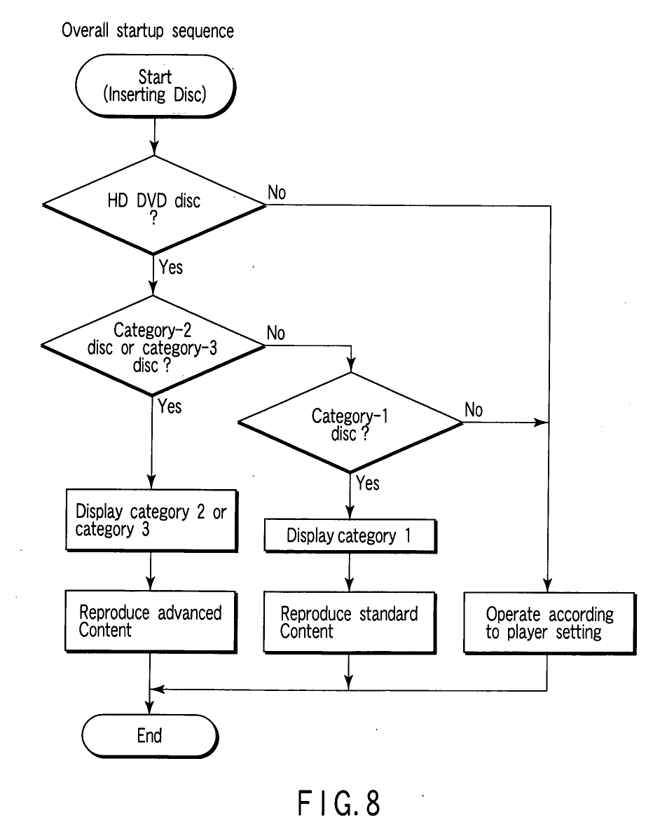

FIG. 8 is a flowchart for a startup sequence of an HD DVD player. After a disc is inserted, the player determines whether “ADV_OBJ” and “playlist.xml(Tentative)” are in “ADV_OBJ” directory under the root directory. If “playlist.xml(Tentative)” exists, the HD DVD player determines that the disc is a disc in category 2 or 3. If “playlist.xml(Tentative)” does not exist, the HD DVD player checks disc VMG_ID in VMGI. If the disc is in category 1, it is “HDDVD_VMG200.” Byte positions 0-bl15 in VMG_CAT indicate only standard categories. If the disc belongs to none of the categories of the HD DVD, the subsequent procedure depends on each player. The reproduction of advanced content differs from that of standard content.

In the above case, the category of each disc is displayed on a display unit or an indicator provided on the body.

<Information Data, Handled by Player>

In each content (such as standard content, advanced content, or interoperable content), several pieces of necessary information data exist in a P-EVOB (primary enhanced video object) to be handled by the player.

The necessary information data include GCI (General Control Information), PCI (Presentation Control Information) and DSI (Data Search Information). These are stored in a navigation pack (NV_PCK). Then, HLI (Highlight Information) is stored in a plurality of HLI packs. Information data to be handled by the player are listed in Table 2. NA means Not applicable.

Note: RDI (Real time Data Information) has been described in the DVD written standards for high-quality writable disc (Part 3, Video Recording Specifications).

TABLE 2
Information data to be handle by player

| Information | | | Interoperable |
|---|---|---|---|
| Data | Standard Content | Advanced Content | Content |
| GCI | Shall be handled | Shall be handled | Shall be handled |
| | by player | by player | by player |
| PCI | Shall be handled | If exist, ignored | NA |
| | by player | by player | |
| DSI | Shall be handled | Shall be handled | NA |
| | by player | by player | |
| HLI | If exist, player | If exist, ignored | NA |
| | shall handle HLI | by player | |
| | by “HLI | | |
| | availability” flag | | |
| (RDI) | NA | NA | Ignored by player |

<Advanced Contentystem Model>

<Data Type of Advanced Content>

Advanced navigation

Advanced navigation is the data type of advanced content navigation data composed of files of the following types:
Playlist
Loading information
Markup
Content
Styling
Timing
Script

<Advanced Data>

Advanced data is the data type of advanced content presentation data. Advance data can be classified into the following four types:
Primary video set
Secondary video set
Advanced element
Others

<Primary Video Set>

A primary video set is a set of primary video data. The data structure of a primary video set, which coincides with that of an advanced VTS, is composed of navigation data (such as VTSI or TMAP) and presentation data (such as P-EVOB-TY2). The primary video set is stored on a disc. In the primary video set, various presentation data can be included. Conceivable presentation stream types are main video, main audio, sub-video, sub-audio, and sub-picture. An HD DVD player can reproduce not only primary video and audio but also sub-video and audio at the same time. While sub-video and sub-audio are being reproduced, sub-video and sub-audio in the secondary video set can be reproduced.

<Secondary Video Set>

A secondary video set is a set of content data pre-downloaded on networking and a file cache. The data structure of a secondary video set, which is a simplified structure of an advanced VTS, is composed of TMAP and presentation data (S-EVOB). In the secondary video set, sub-video, sub-audio, substitute audio, and complementary subtitle can be included. Substitute audio is used as a substitute sudio stream in place of main audio in the primary video set. The complementary subtitle is used as a substitute subtitle stream in place of a sub-picture in the primary video set. The data format of the complementary subtitle is an advanced subtitle.

<Primary Enhanced Video Object Type 2 (P-EVOB-TY2)>

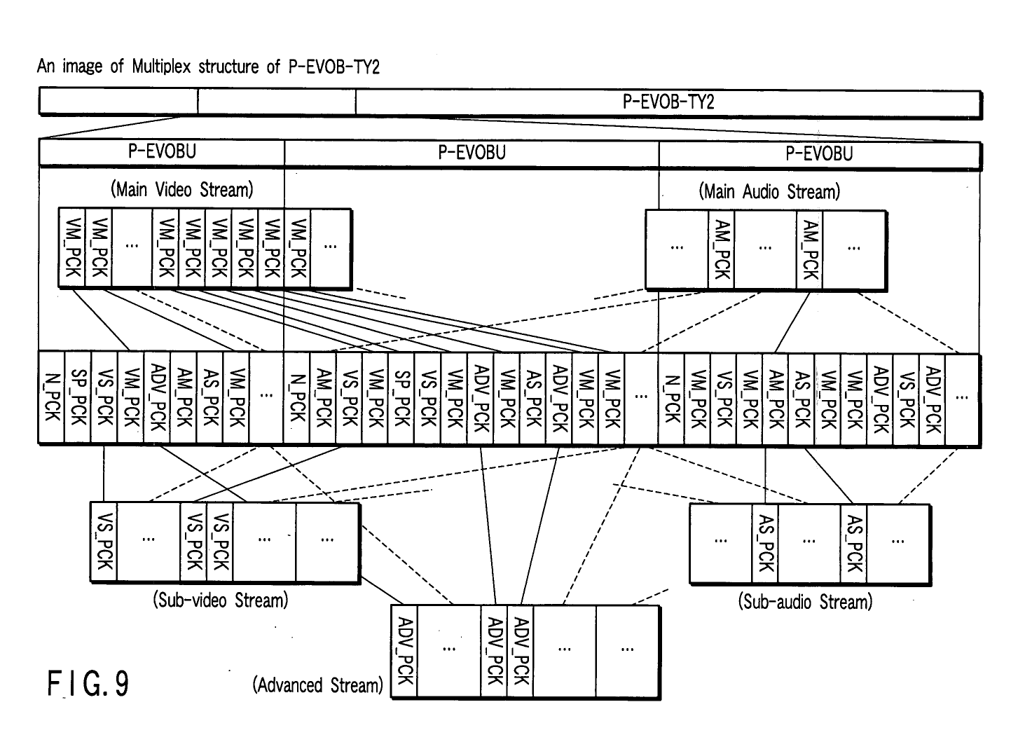

As shown in FIG. 9, primary enhanced video object type 2 (P-EVOB-TY2) is a data stream which carries the presentation data of a primary video set. Primary enhanced video object type 2 (P-EVOB-TY2) complies with a program stream determined in “The system part of the MPEG-2 standard (ISO/IEC 138181-1).” The type of presentation data in the primary video set includes main video, main audio, sub-video, sub-audio, and sub-picture. The advanced stream is further multiplexed with P-EVOB-TY2. Conceivable pack types in P-EVOB-TY2 are:
Navigation pack (N_PCK)
Main video pack (VM_PCK)
Main audio pack (AM_PCK)
Sub-video pack (VS_PCK)
Sub-audio pack (AS_PCK)
Sub-picture pack (SP_PCK)
Advanced stream pack (ADV_PCK)

A time map (TMAP) for primary enhanced video set type 2 has an entry point for each primary enhanced video object unit (P-EVOBU).

A primary video set access unit is based on a main video access unit and a conventional video object (VOB) structure. The sub-video and sub-audio offset information is given from synchronous information. (SYNCI) and main audio and sub-pictures.

An advanced stream is used to supply various types of advanced content files to a file cache without interrupting the reproduction_of the primary video set. The demultiplexing module in the primary video player distributes advanced stream packs (ADV_PCK) to the file cache manager in the navigation engine.

FIG. 9 shows a multiplexing structure of P-EVOB-TY2.

The following models are caused to correspond to P-EVOB-TY2:
Input buffer model for primary enhanced video object type 2 (P-EVOB-TY2)
Decoding model for primary enhanced video object type 2 (P-EVOB-TY2)
Extended system target decoder (E-STD) model for primary enhanced video object type 2 (P-EVOB-TY2)

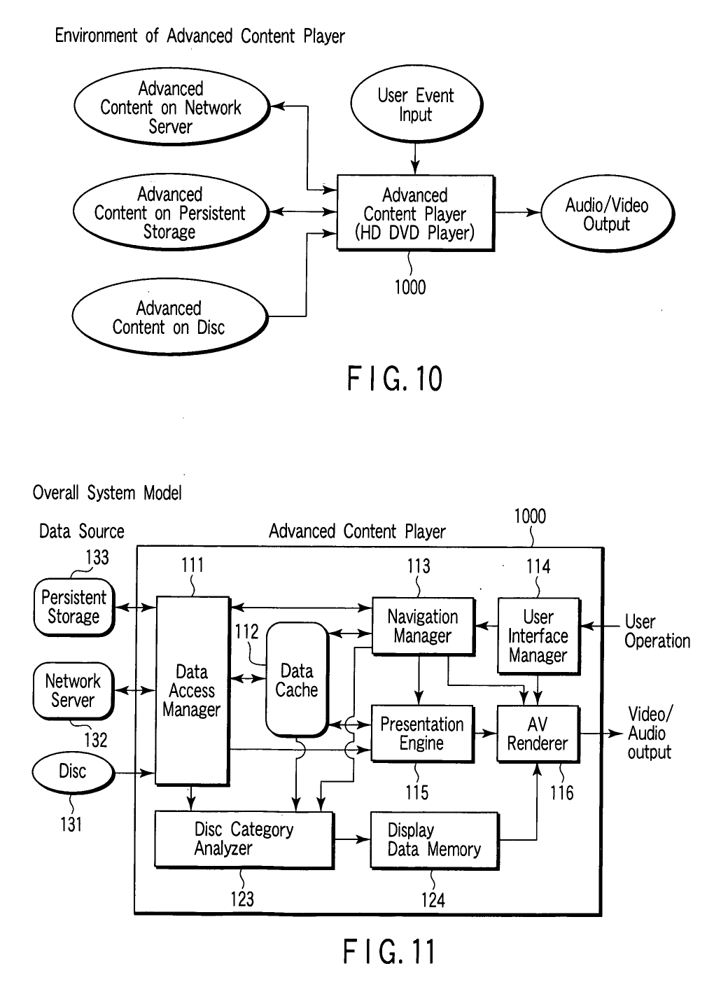

FIG. 10 shows an extended system target decoder model for P-EVOB-TY2.

The packets input via a track buffer to a de-multiplexer are separated by type and supplied to the main video buffer, sub-video buffer, sub-picture buffer, PCI buffer, main audio buffer, and sub-audio buffer. The outputs of the individual buffers can be decoded by the corresponding decoders.

<Environment for Advanced Content>

FIG. 10 shows a playback environment for an advanced content player. The advanced content player is a logical player for advanced content.

Advanced content data sources include a disc, a network server, and a persistent storage. The reproduction of advanced content requires a disc in category 2 or 3. Any data type of advanced content can be stored on a disc. Advanced content for a persistent storage and a network server can store any type of data excluding primary video sets.

A user event input is created by the remote controller of the HD DVD player or a user input unit, such as the front panel. The advanced content player does the job of inputting a user event to the advanced content and creating a proper response. The audio and video outputs are sent to a speaker and a display unit, respectively.

<Overall System Model>

The advanced content player is a player for advanced content. FIG. 11 shows a simplified advanced content player. The player basically comprises the following six logical function modules: a data access manager 111, a data cache 112, a navigation manager 113, a user interface manager 114, a presentation engine 115, and an AV renderer 116.

Further, it includes a live information analyzer 121 which is a feature of this invention and a status display data memory 122.

The data access manager 111 has the function of controlling the exchange of various types of data between data sources and the internal modules of the advanced content player.

The data cache 112 is a temporary data storage for playback advanced content.

The navigation manager 113 has the function of controlling all of the functional modules of the advanced content player according to the description in the advanced navigation.

The user interface manager 114 has the function of controlling user interface units, including the remote controller and front panel of the HD DVD player. The user interface manager 114 informs the navigation manager 113 of the user input event.

The presentation engine 115 has the function of reproducing presentation materials, including advanced elements, primary video sets, and secondary video sets.

The AV renderer 116 has the function of mixing the video/audio inputs from other modules and outputting a signal to an external unit, such as a speaker or a display.

<Data Source>

Next, the types of data sources usable in the reproduction of advanced content will be explained.

<Disc>

A disc 131 is an essential data source for the reproduction of advanced content. The HD DVD player has to include an HD DVD disc drive. Authoring has to be done in such a manner that advanced content can be reproduced even if usable data sources are only a disc and an essential persistent storage.

<Network Server>

The network server 132 is an optional data source for the reproduction of advanced content. The HD DVD player has the capability to access a network. The network server is usually operated by the content provider of the present disc. The network server is generally placed on the Internet.

<Persistent Storage>

The persistent storage 133 is divided into two categories.

One is called Fixed Persistent Storage. This is an essential persistent storage supplied with the HD DVD player. A typical one of this type of storage is a flash memory. The minimum capacity of the fixed persistent storage is 64 MB.

Others, which are optional, are called auxiliary persistent storages. These may be detachable storage units, such as USB memory/HDD or memory cards. One of conceivable auxiliary storage units is NAS. In this standard, the implementation of the unit has not been determined. They must follow the API model for persistent storages.

<About Disc Data Structure>

<Types of Data on Disc>

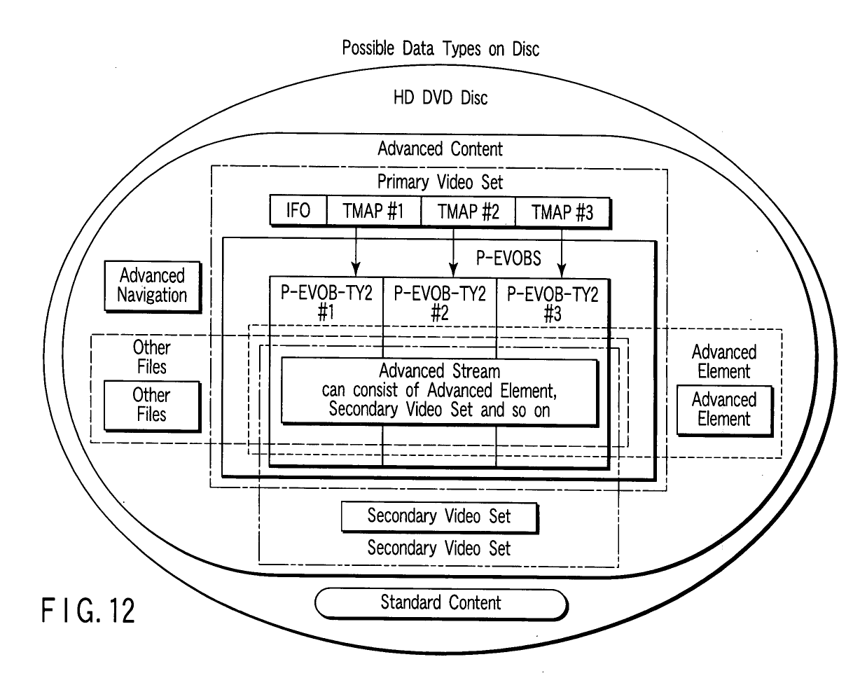

FIG. 12 shows the types of data storable on the HD DVD disc. The disc can store advanced content and standard content. The data types of advanced content includes advanced navigation, advanced elements, primary video sets, and secondary video sets.

FIG. 12 shows conceivable types of data on the disc. An advanced stream has a data format used to archive advanced content files of any type excluding primary video sets. The advanced stream is multiplexed with the primary enhanced video object type 2 (P-EVOBS-TY2) and then is taken out together with P-EVOBS-TY2 data supplied to the primary video player. The same file archived in the advanced stream and indispensable for reproducing advanced content has to be stored as a file. These reproduced copies guarantee the reproduction of advanced content. The reason is that, when the reproduction of the primary video set is jumped, the supply of the advanced stream may not have been completed. In this case, before the reproduction is resumed at the specified jump position, the necessary file is read directly from the disc into the data cache.

Advanced Navigation: An advanced navigation file is ranked as a file. The advanced navigation file is read during the start-up sequence and is interpreted for the reproduction of advanced content.

Advanced Element: An advanced element can be ranked as a file and further can be archived in an advanced stream multiplexed with P-EVOB-TY2.

Primary Video Set: Only one primary video set exists on the disc.

Secondary Video Set: A secondary video set can be ranked as a file and further can be archived in an advanced stream multiplexed with P-EVOB-TY2.

Other Files: Other files may exist, depending on the advanced content.

<Directory and File Configurations>

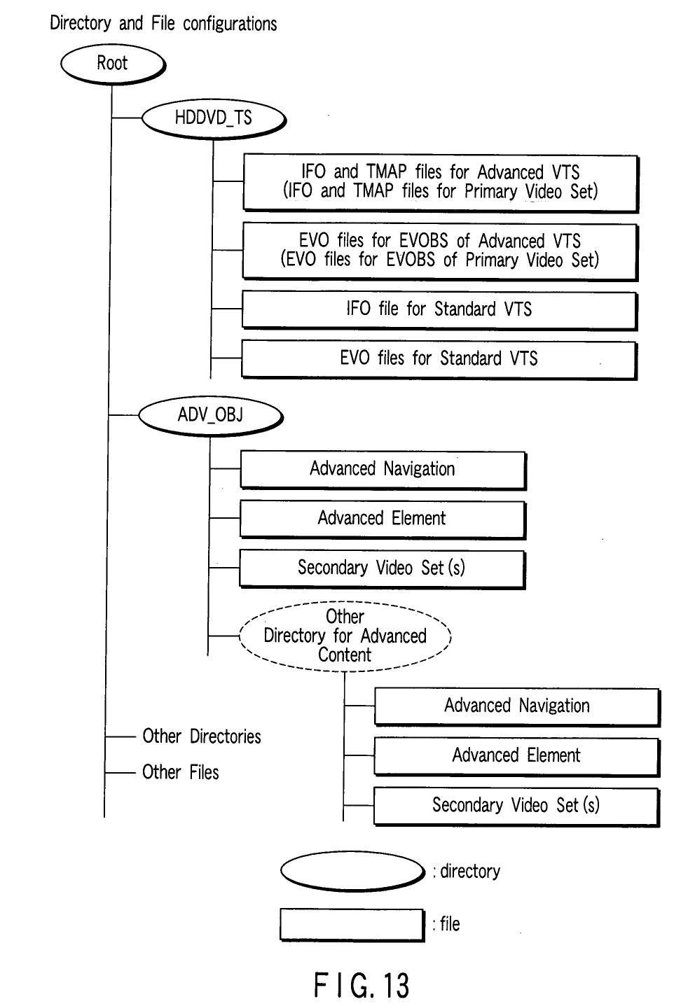

FIG. 13 shows directory and file configurations in the file system. As shown here, it is desirable that advanced content files should be positioned in directories.

HD DVD_TS directory: An HD DVD_TS directory is immediately under the root directory. An advanced VTS for a primary video set and one or more standard video sets are under this directory.

ADV_OBJ directory: An ADV_OBJ directory is just under the root directory. All of the start-up files belonging to the advanced navigation are in this directory. All of the files of advanced navigation, advanced elements, and secondary video sets are in this directory.

Other directories for advanced content: “Other directories for advanced content” can exist only under the ADV_OBJ directory. The files of advanced navigation, advanced elements, and secondary video sets can be placed in this directory. The directory name is composed of d characters and dl characters. Let the total number of ADV_OBJ sub-directories (excluding ADV_OBJ directory) be less than 512. Let the depth of the directory hierarchy be 8 or less.

Advanced content file: The total number of files under the ADV_OBJ directory is limited to 512×2047. Let the total number of files in each directory be less than 2048. The file name is composed of d characters and dl characters. The file name is made up of the body, a dot (.) and an extension.

<Type of Data on Network Server and Persistent Storage>

All of the advanced content files excluding primary video sets can be placed on the network server and persistent storage. Using proper API, advanced navigation can copy a file on the network server or persistent storage into the file cache. The secondary video player can read a secondary video set from the network server or persistent storage into the streaming buffer. Advanced content files excluding primary video sets can be stored into the persistent storage.

<Model of Advanced Content Player>

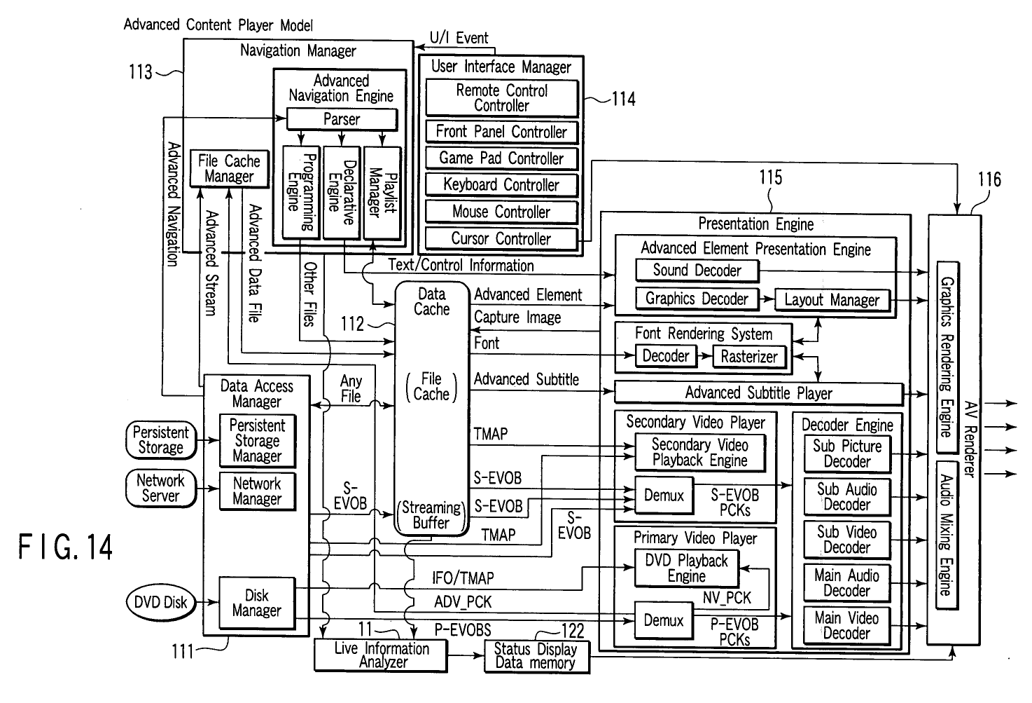

FIG. 14 shows a more detailed model of the advanced content player. The main modules are the following six: data access manager, data cache, navigation manager, presentation engine, user interface manager, and AV renderer.

<Data Access Manager>

Data access manager is composed of disc manager, network manager, and persistent storage manager.

Persistent Storage Manager: Persistent storage manager controls the exchange of data between a persistent storage unit and the internal modules of the advanced content player. The persistent storage manager has the function of providing a file access API set to the persistent storage unit. The persistent storage unit can support the file reading/writing function.

Network Manager: Network manager controls the exchange of data between a network server and the internal modules of the advanced content player. The network manager has the function of providing a file access API set to the network server. The network server usually supports the download of files. Some network servers can also support the upload of files. Navigation manager can execute the download/upload of files between the network server and the file cache according to the advanced navigation. In addition to this, the network manager can provide an access function at a protocol level to the presentation engine. The secondary video player in the presentation engine can use these API sets for streaming from the network server.

<Data Cache>

Data caches are available in two types of temporary storage. One is a file cache acting as a file data temporary buffer. The other is a streaming buffer acting as a streaming data temporary buffer. The allocation of streaming data in the data cache is described in “playlist00.xml. The data is divided in the start-up sequence of the reproduction of advanced content. The size of the data cache is 64 MB minimum. The maximum is undecided.

Initialization of data cache: The configuration of the data cache is changed in the start-up sequence of the reproduction of advanced content. In “playlist00.xml,” the size of the streaming buffer can be written. If there is no description of the streaming buffer size, this means that the size of the streaming buffer is zero. The number of bytes in the streaming buffer size is calculated as follows:

<streamingBuf size=“1024”/>

Streaming buffer size=1024×2 (KB) 2048 (KB)

The minimum size of the streaming buffer is zero bytes and the maximum size is undecided.

File Cache: A file cache is used as a temporary file cache between a data source, a navigation engine, and a presentation engine. Advanced content files of graphics images, effect sound, text, fonts, and others have to be stored in the file cache before they are accessed by the navigation manager_or advanced presentation engine.

Streaming Buffer: A streaming buffer is used as a temporary data buffer for secondary video sets by the secondary video presentation engine of the secondary video player. The secondary video player requests the network manager to load a part of S-EVOB of the secondary video set into the streaming buffer. The secondary video player reads SEVOB data from the streaming buffer and provides the data to the demultiplexer module of the secondary video player.

<Navigation Manager>

A navigation manager is mainly composed of two types of functional modules. They are an advanced navigation engine and a file cache manager.

Advanced Navigation Engine: The advanced navigation engine controls all of the operation of reproducing advanced content and controls the advanced presentation engine according to the advanced navigation. The advanced navigation engine includes a parser, a declarative engine, and a programming engine.

Parser: The parser reads in advanced navigation files and analyzes their syntax. The result of the analysis is sent to a suitable module, declarative engine, and programming engine.

Declarative Engine: The declarative engine manages and controls the declared operation of advanced content according to the advanced navigation. In the declarative engine, the following processes are carried out:
The advance presentation engine is controlled. That is,

Layout of graphics objects and advanced text
Style of graphics objects and advanced text
Timing control of a planned graphics plane operation and an effect sound reproduction
The primary video player is controlled. That is,
Configuration of a primary video set including the registration of title playback sequence (title time line)
Control of a high-level player
The secondary video player is controlled. That is,
Configuration of a secondary video set
Control of high-level layers

Programming Engine: The programming engine manages event-driven behaviors, API interface set calls, or all advanced content. Since the user interface event is usually handled by the programming engine, the operation of the advanced navigation defined in the declarative engine may be changed.

Fine Cache Manager: The file cache manager carries out the following processes:
Providing the files archived in the advanced stream of P-EVOBS from the demultiplexer module of the primary video player
Providing the files archived in the network server or persistent storage
Managing the life time of files in the file cache
Acquiring a file when a request file from the advance navigation or presentation engine has not been stored in the file cache

The file cache manager is composed of an ADV_PCK buffer and a file extractor.

ADV_PCK buffer: The file cache manager receives PCK of the advanced stream archived in P-EVOBS-TY2 from the demultiplexer module of the primary video player. The PS header of the advanced stream PCK is eliminated and basic data is stored in the ADV_PCK buffer. Moreover, the file cache manager acquires an advanced stream file in the network server or persistent storage.

File Extractor: The file extractor extracts an archived file from the advanced stream into the ADV_PCK buffer. The extracted file is stored in the file cache.

<Presentation Engine>

The presentation engine decodes presentation data and outputs an AV renderer according to a navigation command from the navigation engine. The presentation engine includes four types of modules: advanced element presentation engine, secondary video player, primary video player, and decoder engine.

Advanced Element Presentation Engine: The advanced element presentation engine outputs two types of presentation streams to an AV renderer. One is a frame image of a graphics plane and the other is an effect sound stream. The advanced element presentation engine is composed of sound decoder, graphics decoder, text/font rasterizer) or font rendering system, and layout manager.

Sound Decoder: The sound decoder reads a WAV file from the file cache and outputs LPCM data to the AV renderer started up by the navigation engine.

Graphics Decoder: The graphics decoder acquires graphics data, such as PNG images or JPEG images, from the file cache. The graphics decoder decodes these image files and sends the result to the layout manager at the request of the layout manager.

Text/Font Rasterizer: The text/font rasterizer acquires font data from the file cache and creates a text image. The text/font rasterizer receives text data from the navigation manager or file cache. The text/font rasterizer creates a text image and sends it to the layout manager at the request of the layout manager.

Layout Manager: The layout manager creates a frame image of a graphics plane for the AV renderer. When the frame is changed, the navigation manage sends layout information. The layout manager calls the graphics decoder and decodes a specific graphics object to be set on the frame image. Moreover, the layout manager calls the text/font rasterizer and similarly creates a specific text object to be set on the frame image. The layout manager places a graphical image in a suitable place, beginning with the lowest layer. When the object has an alpha channel or a value, the layout manager calculates a pixel value. Finally, the layout manager sends the frame image to the AV renderer.

Advanced Subtitle Player: The advanced subtitle player includes a timing engine and a layout engine.

Font Rendering System: The font rendering system includes a font engine, a scaler, an alphamap Generation, and a font cache.

Secondary Video Player: The secondary video player reproduces auxiliary video content, auxiliary audio, and auxiliary subtitles. These auxiliary presentation content are usually stored in a disc, a network, and a persistent storage. When the content are stored on a disc, it cannot be accessed from the secondary video player unless it has been stored in the file cache. In the case of a network server, the content has to be instantly stored into the streaming buffer before being provided to the demultiplexer/decoder, thereby avoiding data loss due to fluctuations in the bit rate in the network transfer path. The secondary video player is composed of a secondary video playback engine and a demultiplexer secondary video player. The secondary video player is connected to a suitable decoder of the decoder engine according to the stream type of the secondary video set.

Since two audio streams cannot be stored simultaneously into the secondary video set, the number of audio decoders connected to the secondary video player is always one.

Secondary Video Playback Engine: The secondary video playback engine controls all of the functional modules of the secondary video player at the request of the navigation manager. The secondary video playback engine reads and analyzes a TMAM file and compute a suitable reading position of S-EVOB.

Demultiplexer (Dmux): The demultiplexer reads in an S-EVOB stream and sends it to a decoder connected to the secondary video player. Moreover, the demultiplexer outputs a PCK of S-EVOB with SCR timing. When S-EVOB is composed of a stream of video, audio, or advanced subtitle, the demultiplexer provides it to the decoder with suitable SCR timing.

Primary Video Player: The primary video player reproduces a primary video set. The primary video set has to be stored on a disc. The primary video player is composed of a DVD playback engine and a demultiplexer. The primary video player is connected to a suitable decoder of the decoder engine according to the stream type of the primary video set.

DVD Playback Engine: The DVD playback engine controls all of the functional modules of the primary video player at the request of the navigation manager. The DVD playback engine reads and analyzes IFO and TMAP. Then, the DVD playback engine computes a suitable reading position of P-EVOBS-TY2, selects multi-angle or audio/sub-pictures, and controls special reproducing functions, such as sub-video/audio playback.

Demultiplexer: The demultiplexer reads P-EVOBS-TY2 into the DVD playback engine and sends it to a suitable decoder connected to the primary video set. Moreover, the demultiplexer outputs each PCK of P-EVOB-TY2 to each decoder with SCR timing. In the case of multi-angle streams, suitable interleaved blocks of P-EVOB-TY2 on the disc are read according to TMAP or positional information in the navigation pack (N_PCK). The demultiplexer provides a suitable number of the audio pack (A_PCK) to the main audio decoder or sub-audio decoder and a suitable number of the sub-picture pack (SP_PCK) to the SP decoder.

Decoder Engine: The decoder engine is composed of six types of decoders: a timed text decoder, a sub-picture decoder, a sub-audio decoder, a sub-video decoder, a main audio decoder, and a main video decoder. Each decoder is controlled by the playback engine of the player to which the decoder is connected.

Timed Text Decoder: The timed text decoder can be connected only to the demultiplexer module of the secondary video player. At the request of the DVD playback engine, the timed text decoder decodes an advanced subtitle in the format based on timed text. Between the timed text decoder and the sub-picture decoder, one decoder can be activated simultaneously. An output graphic plane is called a sub-picture plane and is shared by the output of the timed text decoder and that of the sub-picture decoder.

Sub-Picture Decoder: The sub-picture decoder can be connected to the demultiplexer module of the primary video player. The sub-picture decoder decodes sub-picture data at the request of the DVD playback engine. Between the timed text decoder and the sub-picture decoder, one decoder can be activated simultaneously. An output graphic plane is called a sub-picture plane and is shared by the output of the timed text decoder and that of the sub-picture decoder.

Sub-Audio Decoder: The sub-audio decoder can be connected to the demultiplexer module of the primary video player and that of the secondary video player. The sub-audio decoder can support two audio channels at a sampling rate of up to 48 kHz. This is called sub-audio. Sub-audio is supported as a sub-audio stream in the primary video set, an audio-only stream in the secondary video set, and further an audio/video multiplexer stream in the secondary video set. An output audio stream of the sub-audio decoder is called a sub-audio stream.

Sub-Video Decoder: The sub-video decoder can be connected to the demultiplexer module of the primary video player and that of the secondary video player. The sub-video decoder can support an SD resolution video stream called sub-video (the maximum support resolution to be prepared). The sub-video is supported as a video stream in the secondary video set and a sub-video stream in the primary video set. The output video plane of the sub-video decoder is called a sub-video plane.

Main Audio Decoder: The primary audio decoder can be connected to the demultiplexer module of the primary video player and that of the secondary video player. The primary audio decoder can support 7.1 audio multichannel at a sampling rate of up to 96 kHz. This is called main audio. Main audio is supported as a main audio stream in the primary video set and an audio-only stream in the secondary video set. An output audio stream of the main audio decoder is called a main audio stream.

Main Video Decoder: The main video decoder is connected only to the demultiplexer of the primary video player. The main video decoder can support an HD resolution video stream. This is called support main video. The main video is supported only in the primary video set. The output plane of the main video decoder is called a main video plane.

<AV Renderer>

The AV renderer has two functions. One function of the AV renderer is to acquire graphic planes from the presentation engine, interface manager, and output mixed video signals. The other function is to acquire PCM streams from the presentation engine and output mixed audio signals. The AV renderer is composed of a graphic rendering engine and a sound mixing engine.

Graphic Rendering Engine: The graphic rendering engine acquires four graphic planes from the presentation engine and one graphic frame from the user interface. The graphic rendering engine combines five planes according to control information from the navigation manager and outputs the combined video signal.

Audio Mixing Engine: The audio mixing engine can acquire three LPCM streams from the presentation engine. The sound mixing engine combines three LPCM streams according to mixing level information from the navigation manager and outputs the combined audio signal.

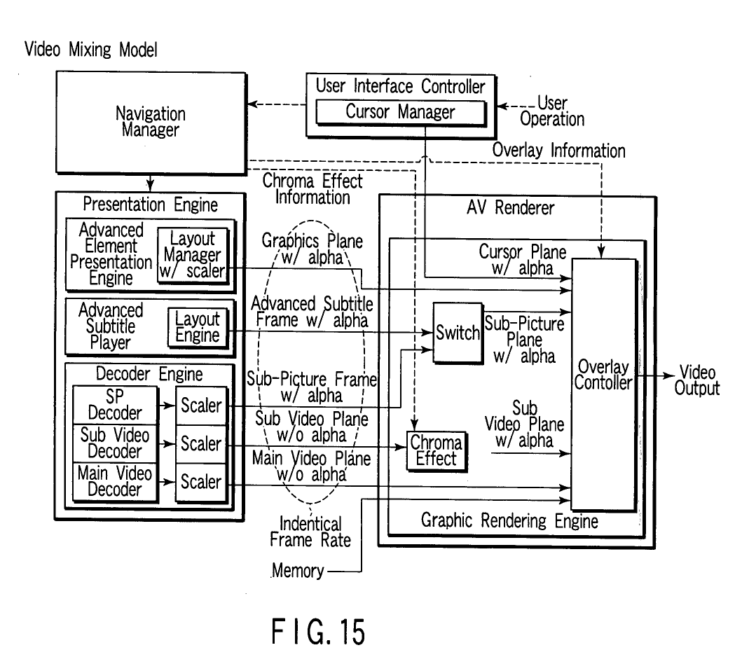

Video Mixing Model: The video mixing model is shown in FIG. 15. Five graphics are input to the model. They are a cursor plane, a graphic plane, a sub-picture plane, a sub-video plane, and a main video plane.

Cursor Plane: The cursor plane is the highest-order plane among the five graphics input to the graphic rendering engine of this model. The cursor plane is created by the cursor manager of the user interface manager. The cursor image can be replaced by the navigation manager according to the advanced navigation. The cursor manager moves the cursor to a suitable position on the cursor plane, thereby updating the cursor with respect to the graphic rendering engine. The graphic rendering engine acquires the cursor plane and alpha mix and lowers the plane according to alpha information from the navigation engine.

Graphic Plane: The graphic plane is the second plane among the five graphics input to the graphic rendering engine of this model. The graphics plane is created by an advanced element presentation engine according to the navigation engine. The layout manager uses the graphic decoder and text/font rasterizer to create a graphics plane. The size and rate of the output frame must be the same as those of the video output of this model. Animation effects can be realized by a series of graphic images (cell animations). The navigation manager of an overlay controller provides no alpha information to the present plane. These values are supplied to the alpha channel of the graphic plane itself.

Sub-Picture Plane: The sub-picture plane is the third plane among the five graphics input to the graphic rendering engine of this model. The sub-picture plane is created by the timed text decoder or sub-picture decoder of the decoder engine. A suitable sub-picture image set of the output frame size can be put in the primary video set. When a suitable size of an SP image is known, an SP decoder transmits the created frame image directly to the graphic rendering engine. When a suitable size of an SP image is unknown, a scaler following the SP decoder measures the suitable size and position of the frame image and transmits the results to the graphic rendering engine.

The secondary video set can include an advanced subtitle for the timed text decoder. The output data from the sub-picture decoder holds alpha channel information.

Sub-Video Plane: The sub-video plane is the fourth plane among the five graphics input to the graphic rendering engine of this model. The sub-video plane is created by the sub-video decoder of the decoder engine. The sub-video plane is measured by the scaler of the decoder engine on the basis of the information from the navigation manager. The output frame rate must be the same as that of the final video output. If information has been given, the clipping of the object shape of the sub-video plane is done by a chroma effect module of the graphic rendering engine. Chroma color (or range) information is supplied from the navigation manager according to the advanced navigation. The output plane from the chroma effect module has two alpha values: one is when the plane is 100% visible and the other is when the plane is 100% transparent. As for the overlay for the main video plane at the bottom layer, an intermediate alpha value is supplied from the navigation manager. The overlaying is done by the overlay control module of the graphic rendering engine.

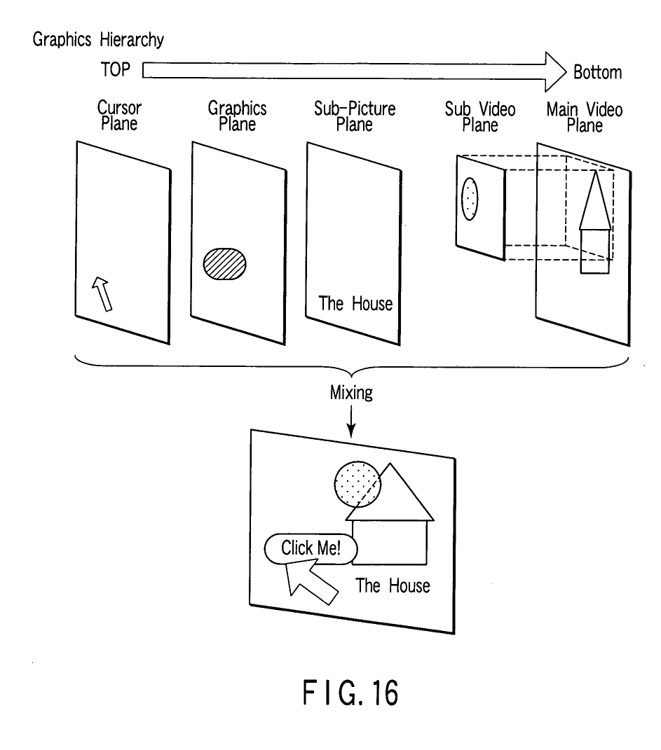

Main Video Plane: The main video plane is the plane at the bottom layer among the five graphics input to the graphic rendering engine of this model. The main video plane is created by the main video decoder of the decoder engine. The main video plane is measured by the scaler of the decoder engine on the basis of the information from the navigation manager. The output frame rate must be the same as that of the final video output. When the navigation manager has made a measurement according to the navigation, an outer frame color can be set to the main video plane. The default color value of the outer frame is “0, 0, 0” (=black). In a graphics hierarchy of FIG. 16, a hierarchy of the graphics plane is shown.

As described above, the advanced player selects a video-audio clip according to the object mapping of the playlist and reproduces the objects included in the clip using the timeline as the time base.

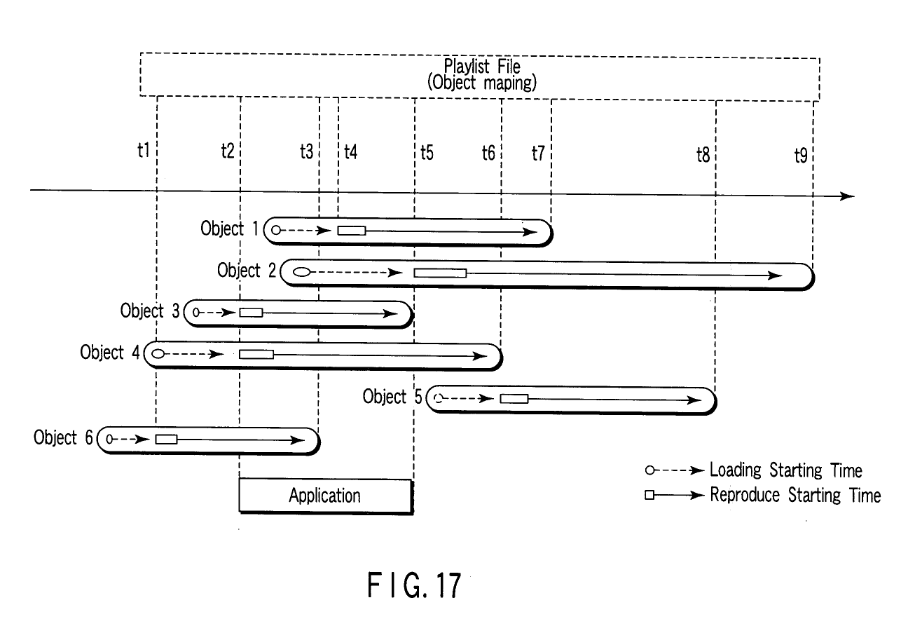

FIG. 17 shows the state in which objects are reproduced according to the playlist. An object 6 is reproduced in a period from time t1 to time t3 on the timeline, an object 4 is reproduced in a period from time t2 to time t6, an object 1 is reproduced in a period from time t4 to time t7, an object 2 is reproduced in a period from time t5 to time t9, and an object 5 is reproduced in a period from time t6 to time t8. Further, an object 3 is reproduced in a period from time t2 to time t5.

In the example shown in FIG. 17, it is understood that an application is started in a period from time t2 to time t5. The objects and applications are loaded into the data cache from the respective clips at time precedent to the reproduction starting time. The data access manager fetches management information containing a time map from an external disk and acquires objects described in the playlist. Then, it outputs objects among the fetched objects which correspond to times (start time, end time) specified by the playlist for temporary storage.

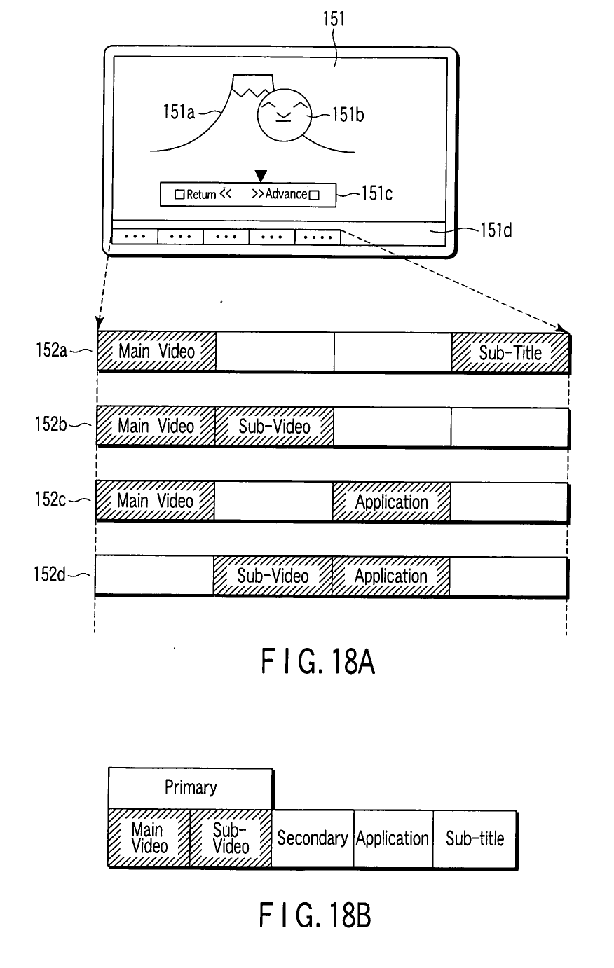

FIGS. 18A and 18B show an example in which video data output from the apparatus of this invention is displayed on the screen of a display device 151. In the case of this device, for example, a main image 151a and sub-video 151b can be simultaneously displayed in a multiplexed form. Further, at this time, a control panel 151c can be displayed based on the application.

In this case, since the live information analyzer 121 and status display data memory 122 explained before are provided, the status indicating that the type of the object of the content and/or the source is displayed on the screen can be displayed.

In order to perform the above status display, a status display area 151d may be provided. In examples 152a to 152d and FIG. 18B, various examples of the status display are indicated. The example 152a is a display example when the main video and sub title are displayed, the example 152b is a display example when the main video and sub-video are simultaneously displayed, the example 152c is a display example when the main video is displayed and the application is started, and the example 152d is a display example when the sub-video is displayed and the application is started.

In the above display examples, the screen 151 of the display device is used as the display section, but the display section may be a display section directly mounted on the information reproducing apparatus. Further, the status display area 151d is not necessary to be always displayed and may be displayed only for a preset period of time when the combination of the objects is changed, that is, when the status is changed. In addition, the status display area 151d can be selectively omitted or displayed according to the user's operation.

As described above, with this apparatus, even when many types of objects are output separately or in a multiplexed manner on the display section, identification data on the objects can be displayed by playlist analysis. Therefore, for example, the sub-video screen where the sub-video is displayed on the entire screen in place of the main video can not be mistaken for the main video screen. As a result of the prevention of such a mistake, the user can operate the apparatus accurately. Since the types of objects include applications taken in by the navigation manager 133, it is possible for an application to control the presentation engine and AV renderer. Moreover, an application may control the state of the output screen according to the user operation. In such a case, for example, when the secondary video is displayed on the entire screen as if it were a slide-show presentation, there is no possibility that the user will take it for the main video screen and perform an angle change operation.

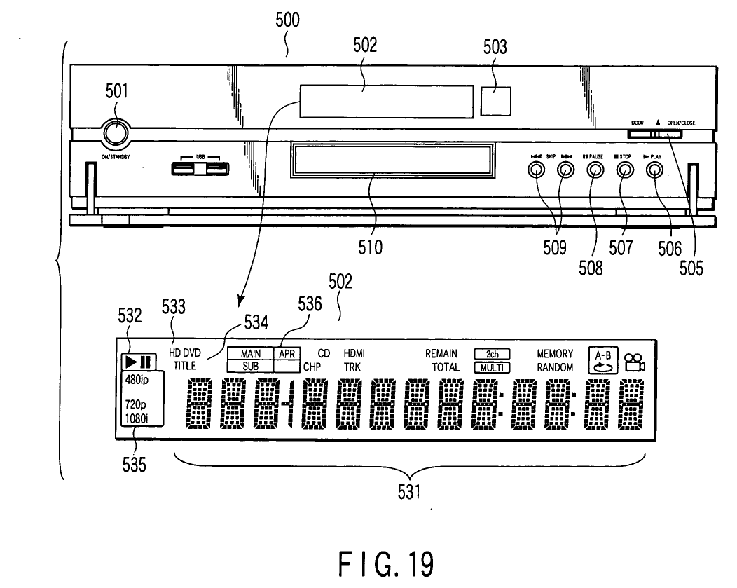

FIG. 19 is a front view showing an information reproducing apparatus 500 to which this invention is applied. A reference symbol 501 denotes a power supply on/off button and 502 denotes a display window corresponding to the display section 134. A reference symbol 503 denotes a remote control receiving section and 505 denotes a door open/close button. A reference symbol 506 denotes a reproducing operation button, 507 a stop operation button, 508 a pause operation button, and 509 a skip operation button. Further, a reference symbol 510 denotes a disk tray, and when the door open/close button 505 is operated, the disk tray protrudes or retracts to permit disks to be exchanged.

In the display window 502, a segment display section 531 is provided and the total reproduction time, elapse time, remaining capacity, title and the like of the disk can be displayed. Further, on a state display section 532, the reproducing operation, stop operation or pause operation can be displayed. Further, a disk identification display section 533 is provided and the type of disk (DVD, HD DVD or the like) loaded thereon can be displayed. A title display section 534 is provided to display the title number. On a display section 535, the degree of resolution of video data now output can be displayed. As described above, in this apparatus, it is possible to easily determine the type of a loaded disk by watching the display section 533. Further, a status display 536 for live information is provided so that main video display, sub-video display and application operation can be easily identified.

The apparatus of the present invention can deal with a single-sided, single-layer DVD, a single-sided, single-layer HD DVD, a single-sided, dual-layer DVD, a single-sided, dual-layer HD DVD, a double-sided DVD, a double-sided HD DVD, a one-side DVD, and a one-other side HD DVD.

The apparatus of the present invention can deal with a single-sided, single-layer DVD, a single-sided, single-layer HD DVD, single-sided, dual-layer DVD, a single-sided, dual-layer HD DVD, a double-sided DVD, a double-sided HD DVD, a one-side DVD, and a one-other side HD DVD.

Hereinafter, to make it easy to understand the necessity for the aforementioned functions, the characteristic configurations and operations of the individual sections of the apparatus of the invention will be explained.

Audio Mixing Model

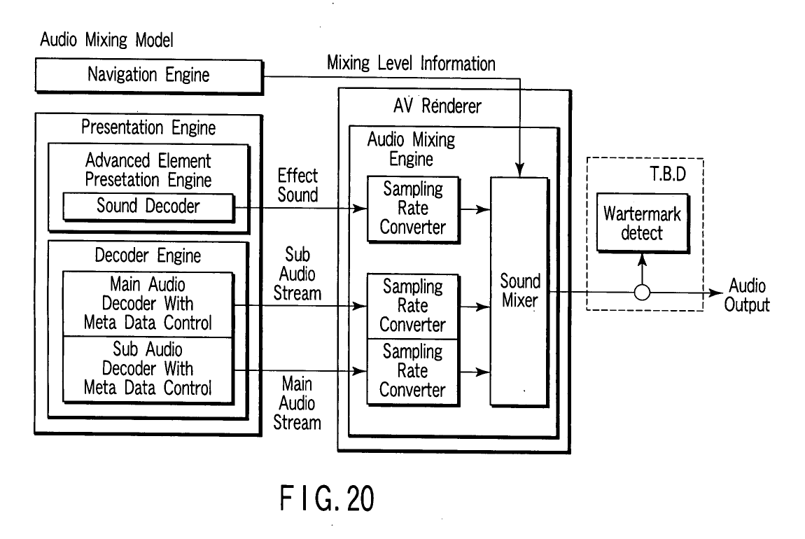

An audio mixing model complying with the specifications is shown in FIG. 20. There are three types of audio streams input to the model. They are effect sound, a secondary audio stream, and a primary audio stream.

A sampling rate converter adjusts the audio sampling rate from the output of each sound/audio decoder to the sampling rate of the final audio output. The static mixing level between three types of audio streams is processed by the sound mixer of the audio mixing engine on the basis of mixing level information from the navigation engine. The final output audio signal differs depending on the HD DVD player.

Effect Sound:

Effect sound is usually used by clicking a graphical button. WAV format for single channels (mono) and stereo channels is supported. The sound decoder reads a WAV file from the file cache and transmits an LPCM stream to the audio mixing engine at the request of the navigation engine.

Sub-Audio Stream:

There are two types of sub-audio streams. One is a sub-audio stream in the secondary video set. When there is a sub-video stream in the secondary video set, the secondary audio has to be the same as the secondary video. When there is no sub-video stream in the secondary video set, the secondary audio may or may not be the same as the primary video set. The other is a sub-audio stream in the primary video. The sub-audio stream has to be the same as the primary video. Metadata in the basic stream of the sub-audio stream is controlled by the sub-audio decoder of the decoder engine.

Main Audio Stream:

The primary audio stream is an audio stream for primary video sets. Metadata in the basic stream of the main audio stream is controlled by the main audio decoder of the decoder engine.

User Interface Manager:

As shown in FIG. 14, the user interface manager includes the following user interface device controllers: a front panel controller, a remote controller, a keyboard controller, a mouse controller, a game pad controller, and a cursor controller. Each controller checks whether the device can be used and monitors user operation events. User input events are notified to the event handler of the navigation manager.

The cursor manager controls the shape and position of the cursor. The cursor manager updates the cursor plane according to the moving event from a related device, such as the mouse or game controller.

<Disc Data Supply Model>

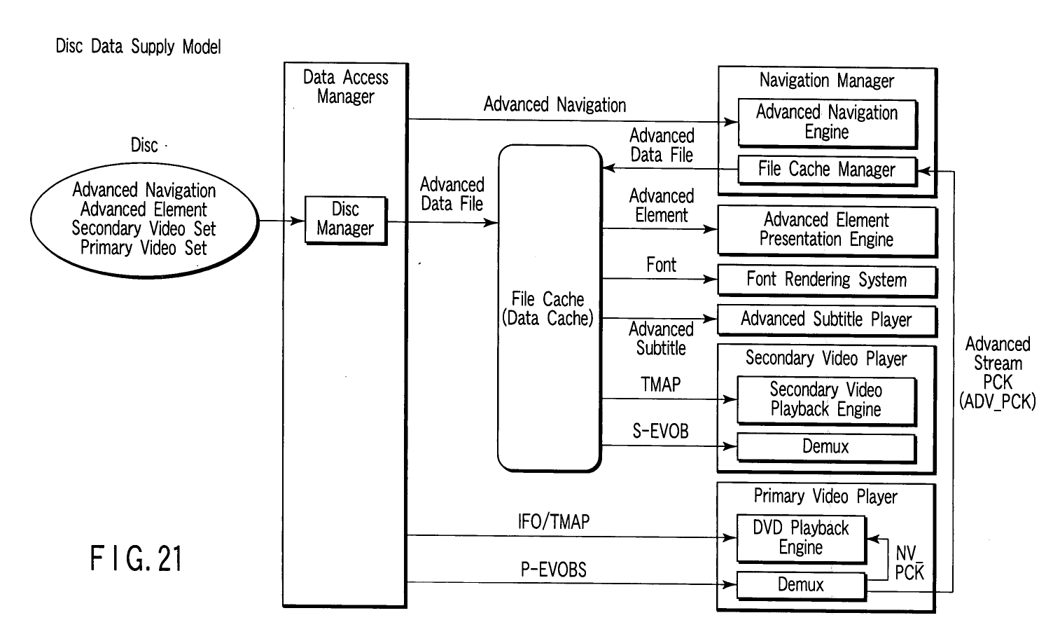

FIG. 21 shows a data supply model for advanced content from a disc.

The disc manager provides a low-level disc access function and a file access function. Using a file access function, the navigation manager acquires a start-up sequence advanced navigation. Using both of the functions, the primary video player can acquire an IFO file and a TMAP file. Using a low-level disc access function, the primary video player makes a request to acquire the position where P-EVOBS is specified. The secondary player never accesses the data on the disc directly. The file is immediately stored in the file cache and is read by the secondary video player.

When the demultiplexer module of the primary video decoder has demultiplexed P-EVOB-TY2, it is possible that an advanced stream pack (ADV_PCK) exists. The advanced stream pack is sent to the file cache manager. The file cache manager extracts a file archived in the advanced stream and stores it in the file cache.

<Network and Persistent Storage Data Supply Model>

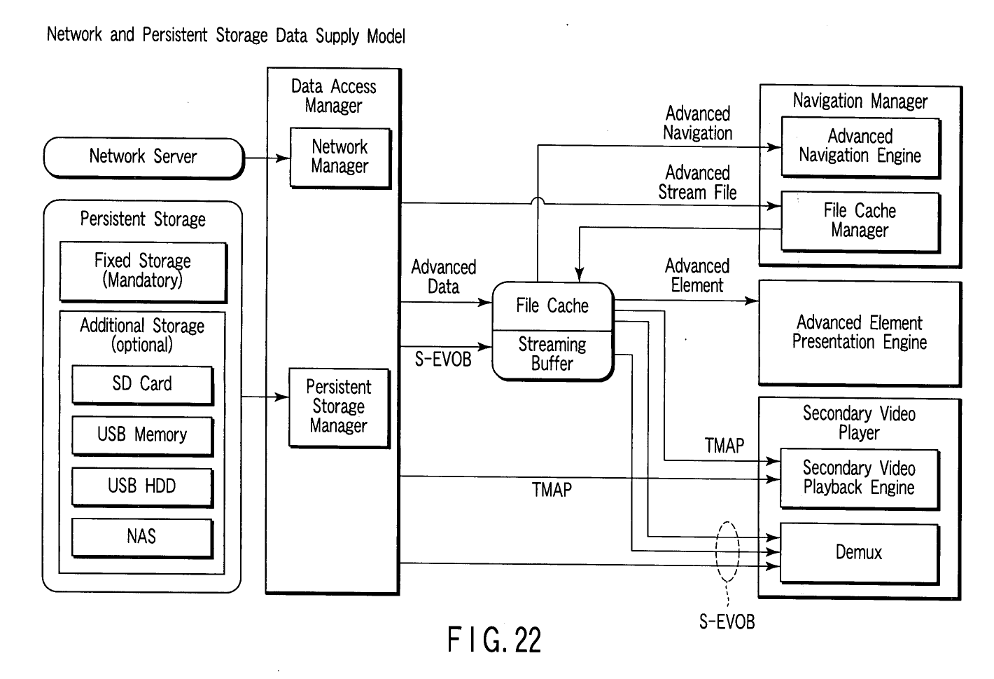

A network and persistent storage data supply model in FIG. 22 shows a data supply model for advanced content from a network server and persistent storage.

The network server and persistent storage can store all of the advanced content files excluding the primary video sets. The network manager and persistent storage manager provide a file access function. The network manager further provides an access function at the protocol level.

The file cache manager of the navigation manager can acquire an advanced stream file (in the archive format) directly from the network server and persistent storage via the network manager and persistent storage manager. The advanced navigation engine cannot access the network server and persistent storage directly. The file has to be immediately stored in the file cache before the advanced navigation engine reads the file.

The advanced element presentation engine can process a file in the network server and persistent storage. The advanced element presentation engine reads the file cache manager and acquires a file not in the file cache. The file cache manager makes a comparison with a file cache table, thereby determining whether the requested file has been cached in the file cache. If the file exists in the file cache, the file cache manager hands over the file data to the advanced presentation engine directly. If the file does not exist in the file cache, the file cache manager acquires the file from the original place into the file cache and hands over the file data to the advanced presentation engine.

Like the file cache, the secondary video player acquires a secondary video set file, such as TMAP or S-EVOB, from the network server and persistent storage via the network manager and persistent storage manager. Generally, using the streaming buffer, the secondary video playback engine acquires S-EVOB from the network server. The secondary video playback engine stores part of S-EVOB data into the streaming buffer and supplies it to the demultiplexer module of the secondary video player.

<Date Store Model>

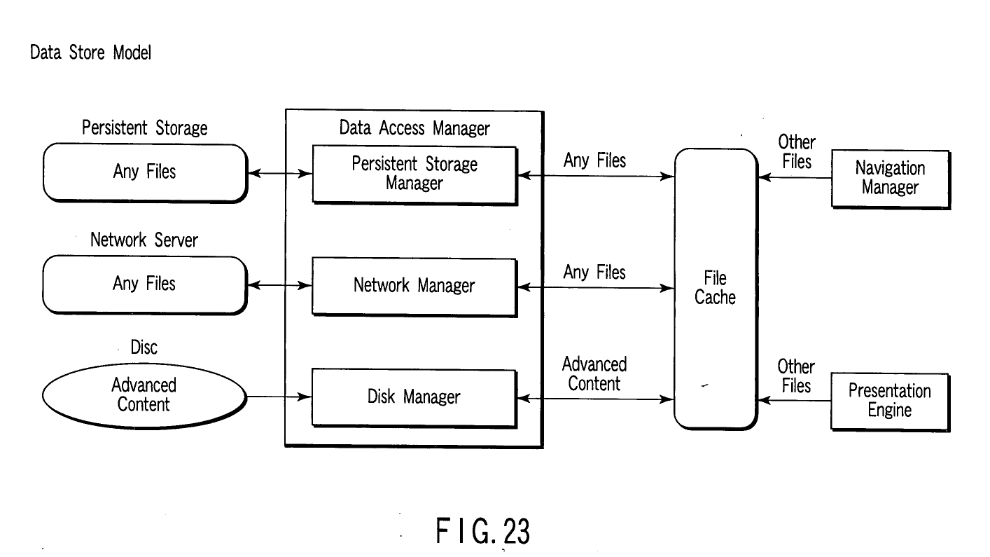

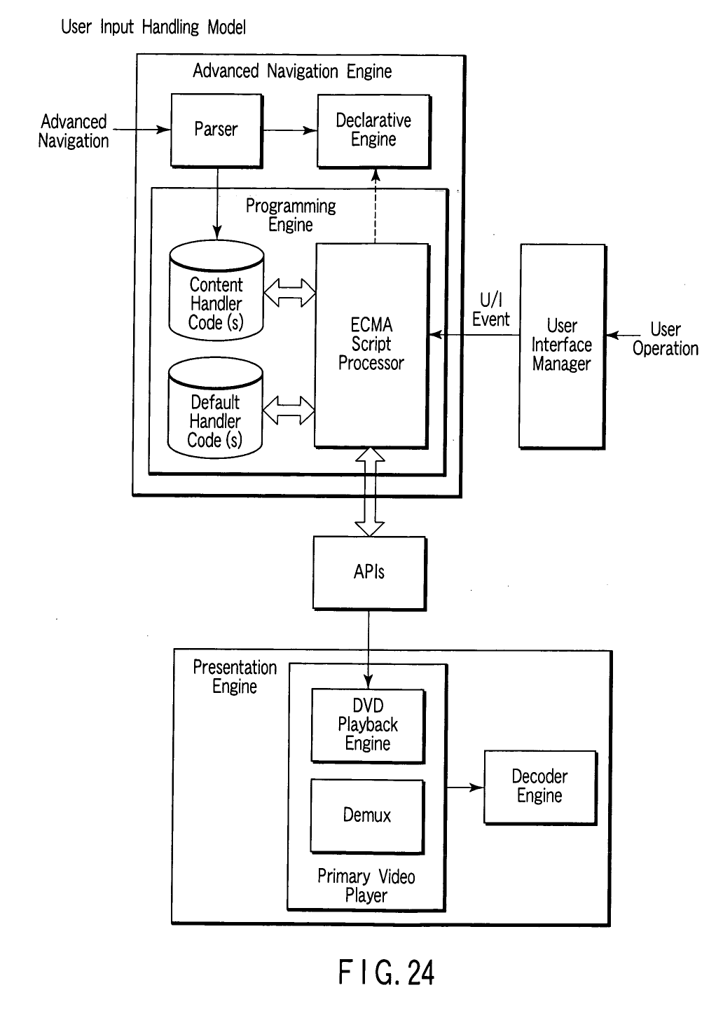

A data store model in FIG. 23 will be explained. There are two types of data storage: persistent storage and a network server. When an advanced content is reproduced, two types of files are created. One is of an exclusive-use type and is created by the programming engine of the navigation manager. The format differs, depending on the description made by the programming engine. The other file is an image file and is collected by the presentation engine.

<User Input Model (FIG. 24)>

All user input events are handled by the programming engine. The user operation via the user interface device, such as the remote controller or front panel, is input to the user interface manager first. The user interface manager converts the input signal from each player into an event defined as “UIEvent” in “InterfaceRemoteControllerEvent.” The converted user input event is transmitted to the programming engine.

The programming engine has an ECMA script processor, which executes a programmable operation. The programmable operation is defined by the description of ECMA script provided by the script file of the advanced navigation. The user event handler code defined in the script file is registered in the programming engine.

When the ECMA script processor has received the user input event, the ECMA script processor checks whether the handler code corresponds to the present event registered in the content handler code. If it has been registered, the ECMA script processer executes it. If not, the ECMA script processor searches for a default handler code. If the corresponding default handler code exists, the ECMA script processor executes it. If not, the ECMA script processor either cancels the event or outputs a warning signal.
Video Output Timing: The reproduced decoded video is controlled by the decoder engine and is output to the outside.
SD Conversion of Graphic Plane: The graphic plane is created by the layout manager of the advanced element presentation engine. If the created frame resolution does not coincide with the final video output resolution of the HD DVD player, the scaler function of the layout manager measures the graphic frame according to the present output mode, such as an SD pan scan or an SD letter box. There are also provided a scaling function for doing a pan scan and a scaling function for obtaining a letter box output.

<Presentation Timing Model>

The advanced content presentation is managed using master time that defines a synchronous relationship between a presentation schedule and a presentation object. Master time is called title timeline. The title timeline, which is defined for each logical playback time, is called a title. A timing unit of the title timeline is 90 kHz. There are five types of presentation units: primary video set (PVS), secondary video set (SVS), auxiliary audio, auxiliary subtitle, and advanced application (ADV_APP).

<Presentation Object>

The five types of presentation objects are as follows:
Primary video set (PVS)
Secondary video set (SVS)
Sub-video/sub-audio
Sub-video
Sub-audio
Auxiliary audio (for primary video sets)
Auxiliary subtitle (for primary video sets)

Advanced application (ADV_APP)

<Attributes of Presentation Object>

A presentation object has two types of attributes: one is “scheduled” and the other is “synchronized.”

<Scheduled Presentation Object and Synchronized Presentation Object>

The beginning time and ending time of this object type are allocated to playlist files in advance. The presentation timing is synchronized with respect to the time of the title timeline. The primary video set, auxiliary audio, and auxiliary subtitle belong to this object type. Secondary video sets and advanced applications are treated as this object type.

<Scheduled Presentation Object and Unsynchronized Presentation Object>

The beginning time and ending time of this object type are allocated to playlist files in advance. The presentation timing is its own time base. Secondary video sets and advanced applications are treated as this object type.

<Unscheduled Presentation Object and Synchronized Presentation Object>

This object type is not written in the playlist file. This object is started up by a user event handled by the advanced application. The presentation timing is synchronized with respect to the title timeline.

<Unscheduled Presentation Object and Unsynchronized Presentation Object>

This object type is not written in the playlist file. This object is started up by a user event handled by the advanced application. The presentation timing is its own time base.

<Playlist File>

There are two intended uses of a playlist file in reproducing advanced content. One is for an initial system configuration of the HD DVD player and the other is for the definition of a method of playing a plurality of presentation content in the advanced content. The playlist file is composed of the following configuration information on the reproduction of advanced content:
Object mapping information on each title
Playback sequence of each title
System configuration of the reproduction of advanced content

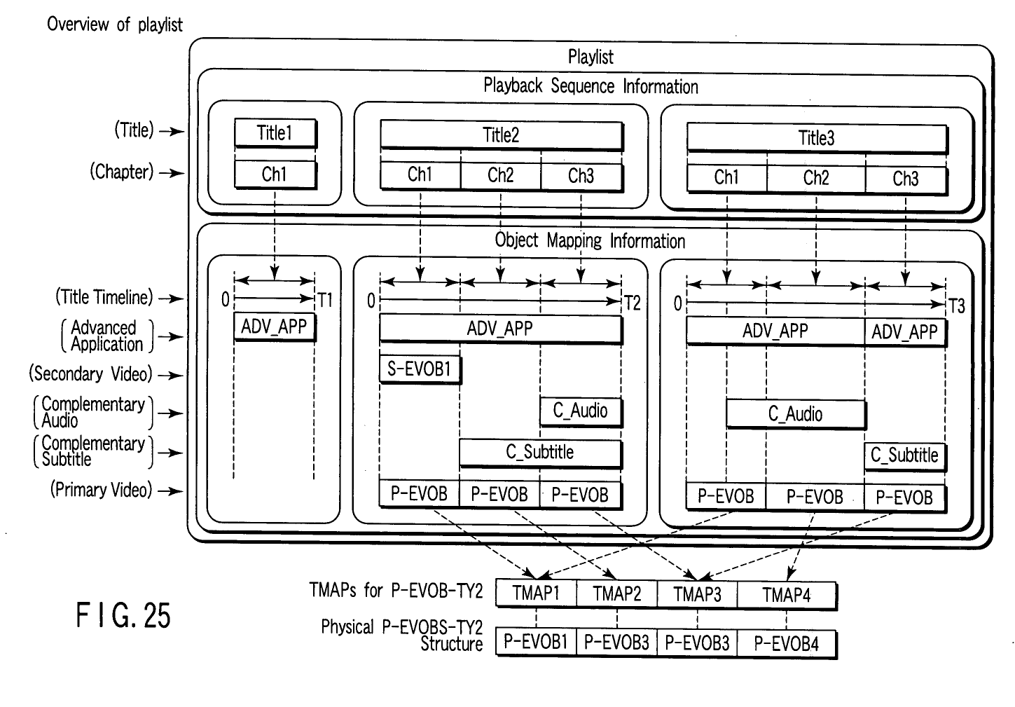

FIG. 25 shows an overview of a playlist with the system configuration removed.

<Object Mapping Information>

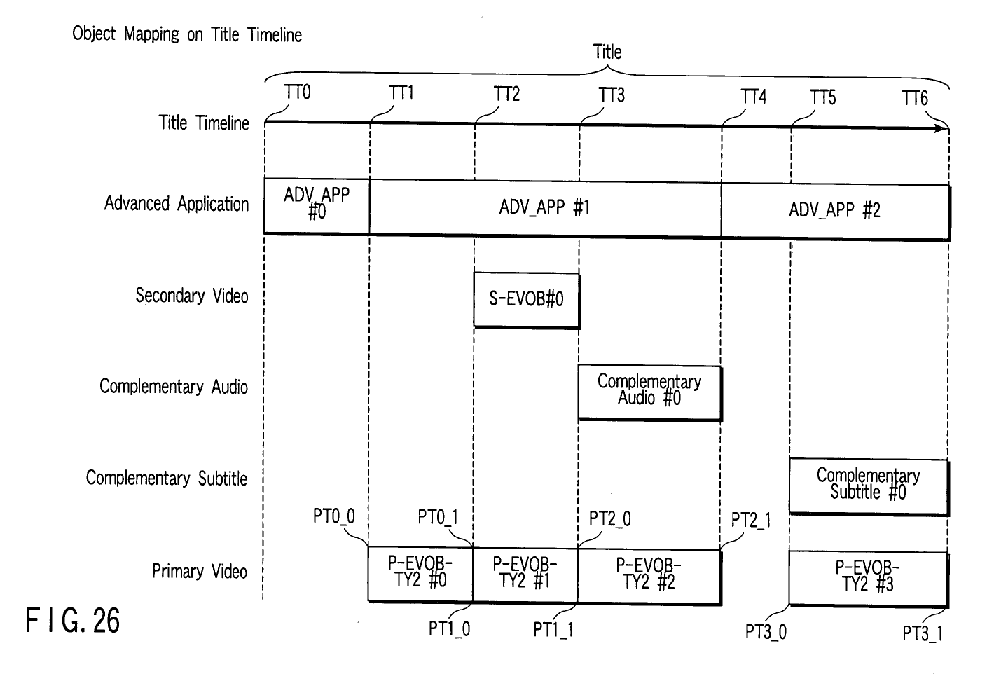

The title timeline defines the timing relationship between a default playback sequence and a presentation object for each title. The operating time (from the beginning time to the ending time) of a scheduled presentation object, such as an advanced application, a primary video set, or a secondary video set, is allocated to the title timeline in advance. FIG. 26 is a diagram to help explain object mapping on the title timeline. As time elapses on the timeline, each presentation object begins and ends its presentation. When the presentation object has been synchronized with the title timeline, the operating time of the title timeline allocated in advance becomes equal to the presentation time.

Example) TT2−TT1=PT1_1−PT1_0

PT_1 is the presentation beginning time of P-EVOB-TY2#1 and PT_0 is the presentation ending time of P-EVOB-TY2#1.

The following explanation is about a case example of object mapping information.

```
    <Title id=”MainTitle”>
        <PrimaryVideoTrack id=”MainTitlePVS”>
            <Clip id=”P-EVOB-TY2-0”
src=“file:///HDDVD_TS/AVMAP001.IFO”
              titleTimeBegin=”01:00:00:00”
titleTimeEnd=”02:00:00:00” clipTimeBegin=”0”/>
            <Clip id=”P-EVOB-TY2-1”
src=”file:///HDDVD_TS/AVMAP002.IFO”
              titleTimeBegin=”02:00:00:00”
titleTimeEnd=”03:00:00:00” clipTimeBegin=”0”/>
            <Clip id=”P-EVOB-TY2-2”
src=”file:///HDDVD_TS/AVMAP003.IFO”
              titleTimeBegin=”03:00:00:00”
titleTimeEnd=”04:50:00:00” clipTimeBegin=”0”/>
            <Clip id=”P-EVOB-TY2-3”
src=”file:///HDDVD_TS/AVMAP005.IFO”
              titleTimeBegin=”05:00:00:00”
titleTimeEnd=”06:50:00:00” clipTimeBegin=”0”/>
        </PrimaryVideoTrack>
        <SecondaryVideoTrack id=”CommentarySVS”>
            <Clip id=”S-EVOB-0”
src=”http://dvdforum.com/commentary/AVMAP001.TMAP”
              titleTimeBegin=”05:00:00:00”
titleTimeEnd=”06:50:00:00” clipTimeBegin=”0”/>
        </SecondaryVideoTrack>
        <Application id=”App0”
manifest=”file:///ADV_OBJ/App0/Manifest.xml” />
        <Application id=”App0”
manifest=”file:///ADV_OBJ/App1/Manifest.xml” />
    </Title>
```

Restrictions are placed on the object mapping between the secondary video sets, auxiliary audios, and auxiliary subtitles.

Since these three presentation objects are reproduced by the secondary video player, two or more of these presentation objects are not permitted to be mapped on the title timeline at the same time.

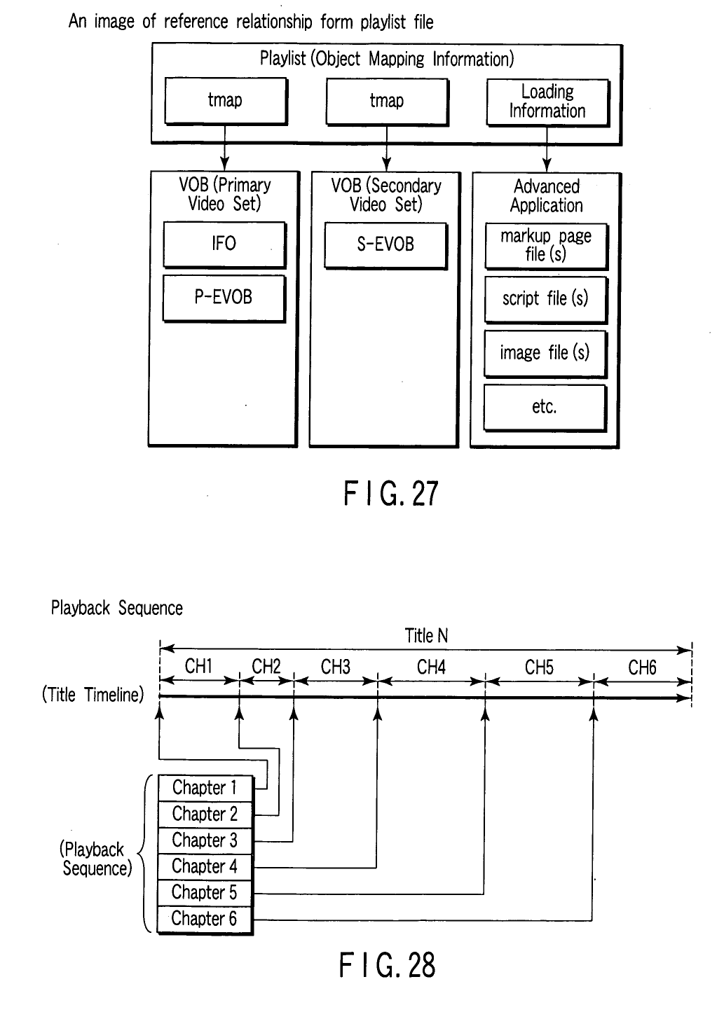

When presentation objects are allocated in advance on the title timeline of the playlist, an index information file of each presentation object is referred to. In the case of primary video sets and secondary video sets, the TMAP. file is referred to in the playlist as shown FIG. 27.

<Playback Sequence>

As shown in FIG. 28, the playback sequence defines the starting position of the chapter using the time value of the title timeline. The starting position of the next chapter or the end of the title line of the last chapter is used as the ending place of the chapter.

The following explanation is about a case example of a playback sequence.

```
<ChapterList>
    <Chapter titleTimeBegin=“0”/>
    <Chapter titleTimeBegin=“01:00:00:00”/>
    <Chapter titleTimeBegin=“02:00:00:00”/>
    <Chapter titleTimeBegin=“02:55:00:00”/>
    <Chapter titleTimeBegin=“03:00:00:00”/>
    <Chapter titleTimeBegin=“04:55:55:00”/>
</ChapterList>
```

<Trick Play>

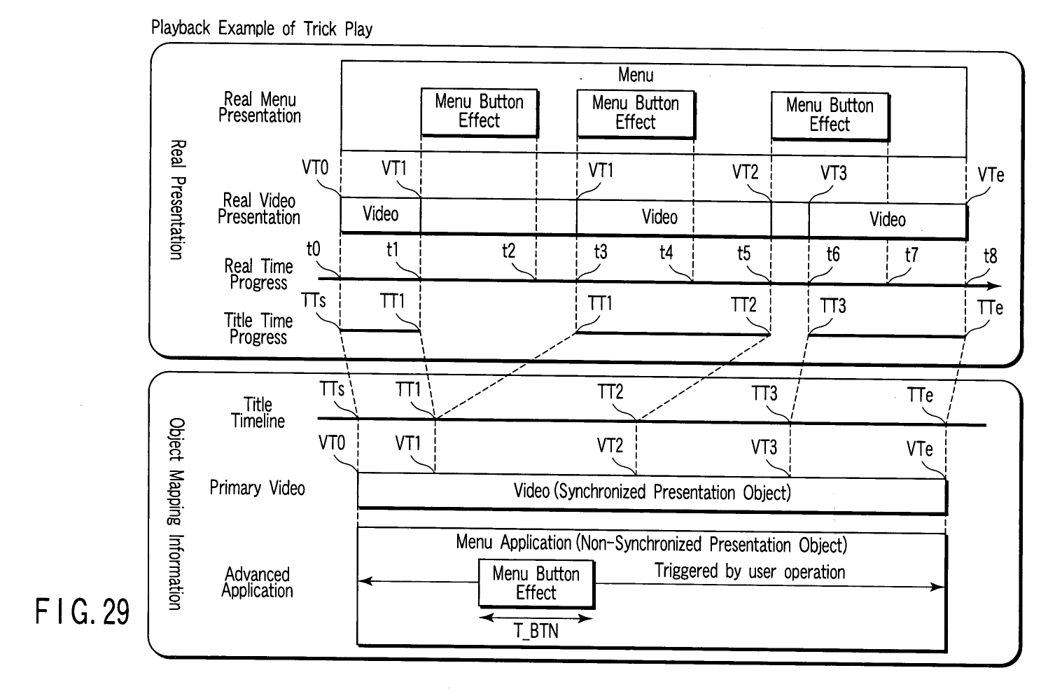

In a playback example of a trick play in FIG. 29, related object mapping information on the title timeline and a real presentation are shown.

There are two presentation objects. One is a primary video, a synchronized presentation object. The other is a menu advanced application, an unsynchronized presentation object. In the menu, the primary video is supposed to be provided with a playback control menu. To achieve this, a plurality of menu buttons to be clicked in the user operation are supposed to be included. The menu buttons have a graphical effect. The effect duration “T_BTN.”

<Real Time Elapsed (t0)>

At time “t0” in the elapse of real time, an advanced content presentation is started. As time elapses on the title timeline, the primary video is reproduced. Although the presentation of the menu application is also started at time “t0,” its presentation does not depend on the elapse of time on the timeline.

<Real Time Elapsed (tl)>

At time “t1” in the elapse of real time, the user clicks “Pause” button displayed on the menu application. At that time, the script related to “Pause” button causes the elapse of time on the timeline to pause at TT1. When the title timeline is caused to suspend, the video presentation also pauses at VT1. In contrast, the menu application continues the operation. That is, the menu application is started at “t1” as a result of the effect of the menu button related to “Pause” button.

<Real Time Elapsed (t2)>

At time “t2” in the elapse of real time, the effect of the menu button is terminated. Time “t−t1” is equal to the button effect duration “T_BTN.”

<Real Time Elapsed (t3)>

At time “t3” in the elapse of real time, the user clicks “Play” button displayed by the menu application. At that time, the script related to “Play” button starts the elapse of time on the timeline at TT1. When the title timeline is started, the video presentation is also started at VT1. The menu application is started at “t3” as a result of the effect of the menu button related to “Play” button.

<Real Time Elapsed (t4)>

At time “t4” in the elapse of real time, the effect of the menu button is terminated. Time “t3−t4” is equal to the button effect duration “T_BTN.”

<Real Time Elapsed (t5)>

At time “t5” in the elapse of real time, the user clicks “Jump” button displayed by the menu application. At that time, the script related to “Jump” button causes time on the timeline to jump by a specific jump time TT3. Since the jump operation of the video presentation requires some time, time on the title timeline at that time remains at “t5.” In contrast, the menu application continues the operation and has nothing to do with the elapse of time on the title timeline, with the result that the menu application is started at “t5” as a result of the effect of the menu button related to “Jump” button.

<Real Time Elapsed (t6)>

At time “t6” in the elapse of real time, the video presentation is ready to start at VT3 at any time. At this time, the title timeline starts at TT3. When the title timeline starts, the video presentation is also started at VT3.

<Real Time Elapsed (t7)>

At time “t7” in the elapse of real time, the effect of the menu button is terminated. Time “t7−t5” is equal to the button effect duration “T_BTN.”

<Real Time Elapsed (t8)>

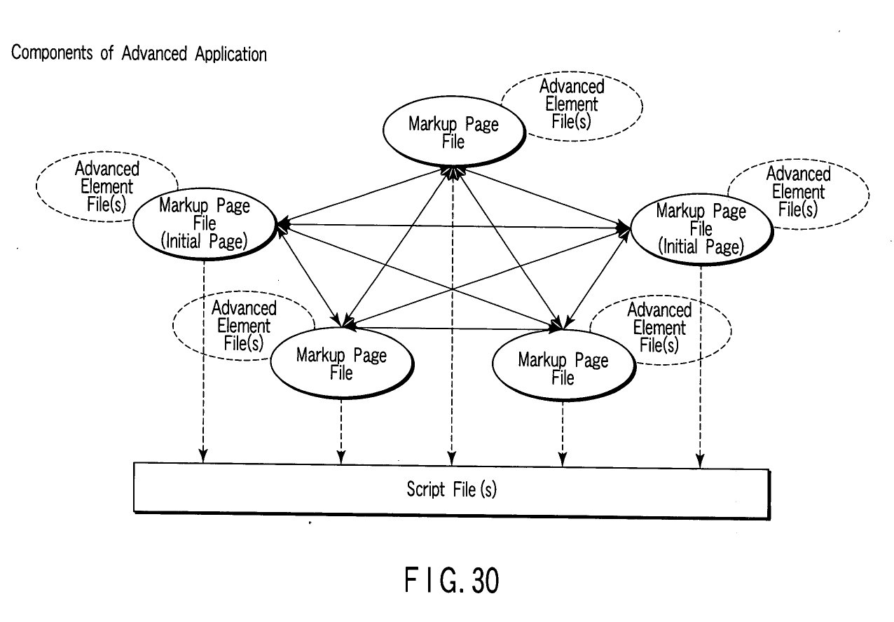

At time “t8” in the elapse of real time, the timeline has reached the ending time TTe. Since the video presentation also has reached VTe, the presentation is terminated. Since the operating time of the menu application has been allocated to TTe on the title timeline, the presentation of the menu application is also terminated at TTe.

<Advanced Application: See FIG. 30)>

An advanced application (ADV_APP) is composed of a one-way or a two-way mutual-link markup page file, a script file sharing a name space belonging to the advanced application, and an advanced element file used by a markup page and a script file.

In the presentation of the advanced application, the number of active markup pages is always one. An active markup page jumps from one to another.

<Explanation of Advanced Content Playback Sequence>

<Start-up Sequence of Advanced Content>

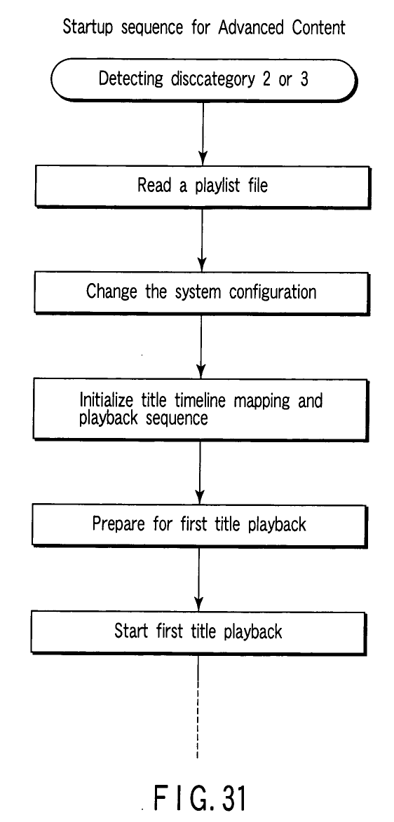

FIG. 31 is a flowchart to help explain a start-up sequence of advanced content on a disc.

Reading an initial playlist file:

When it is sensed that the disc category type of the inserted HD DVD disc is 2 or 3, the advanced content player reads in sequentially an initial playlist file which holds the object mapping information, playback sequence, and system configuration.

Change of System Configuration:

The player changes the system resource configuration of the advanced content player. The streaming buffer size is changed according to the streaming buffer size written in the playlist file at this stage. At this point in time, the files and data in the file cache and streaming buffer are all deleted.

Initialization of Title Timeline Mapping and Playback Sequence:

The navigation manager calculates a presentation place and a chapter entry point for the presentation objects on the title timeline of the first title.

Preparation for first title playback:

Before starting to reproduce the first title, the navigation manager reads in and stores all of the files to be stored in the file cache. These are the advanced element files of the advanced element presentation engine or the TMAP/S-EVOB files of the secondary video player engine. At this stage, the navigation manager initializes presentation modules, including the advanced element playback engine, secondary video player, and primary video player.

When the first title has a primary video presentation, the navigation manager informs the title timeline of the first title of presentation mapping information about the primary video set and specifies the navigation file of a primary video set, such as F0 and TMAP. The primary video player reads IF0 and TMAP from the disc and prepares internal parameters to control the reproduction of the primary video set according to the notified presentation mapping information. Moreover, the primary video player is connected to the necessary decoder modules of the decode engine.

When the presentation objects played by the secondary video player, such as secondary sets, auxiliary audio, or auxiliary subtitles, exist in the first title, the navigation manager notifies presentation mapping information about the first presentation object on the title timeline. Moreover, the navigation manger specifies a navigation file for a presentation object, such as TMAP. The secondary video player reads in TMAP from the data source and prepares internal parameters to control the reproduction of the presentation object according to the notified presentation mapping information. Moreover, the secondary video player is connected to the requested decode module of the decoder engine.

Starting the play of the first title:

After the preparation of the playback of the first title is completed, the advanced content player starts the title timeline. The presentation object mapped on the title timeline starts a presentation according to the presentation schedule.

<Update Sequence of Advanced Content Playback>

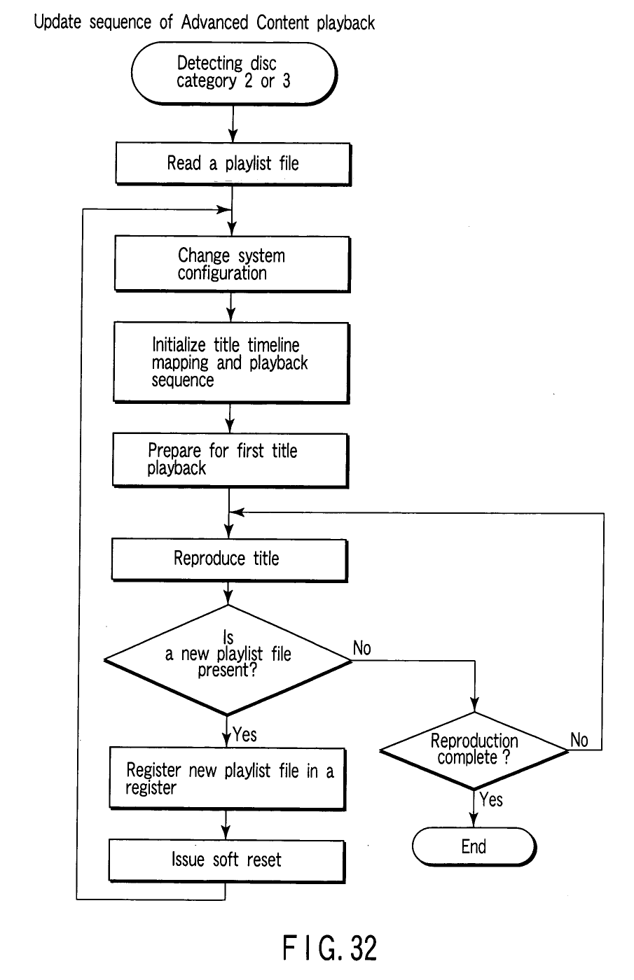

FIG. 32 is a flowchart to help explain an update sequence of advanced content playback. The part from “Read the playlist file” to “Prepare for the first title playback” is the same as that in the start-up sequence of advanced content.

Playback Title:

The advanced content player reproduces a title.

New playlist file present or absent?:

To update the advanced content playback, an advanced application to execute an update procedure is needed. When the advanced application updates the presentation, the advanced application of the disc has to retrieve the script sequence in advance and update it. The programming script searches the specified database, normally the network server, regardless of whether a new usable playlist file is present.

Registering a playlist file:

When a new usable playlist file is present, the script executed by the programming engine downloads the file into the file cache and registers the file in the advanced content player.

Issuing Soft Reset:

When a new playlist file has been registered, the advanced navigation issues soft reset API, thereby staring the start-up sequence again. The soft reset API resets all of the present parameters and the playback configuration and starts the start-up procedure again immediately after “Read the playlist file.” “Update the system configuration” and the subsequent procedure are executed on the basis of the new playlist file.

<Sequence of Conversion Between Advanced VTS and Standard VTS>

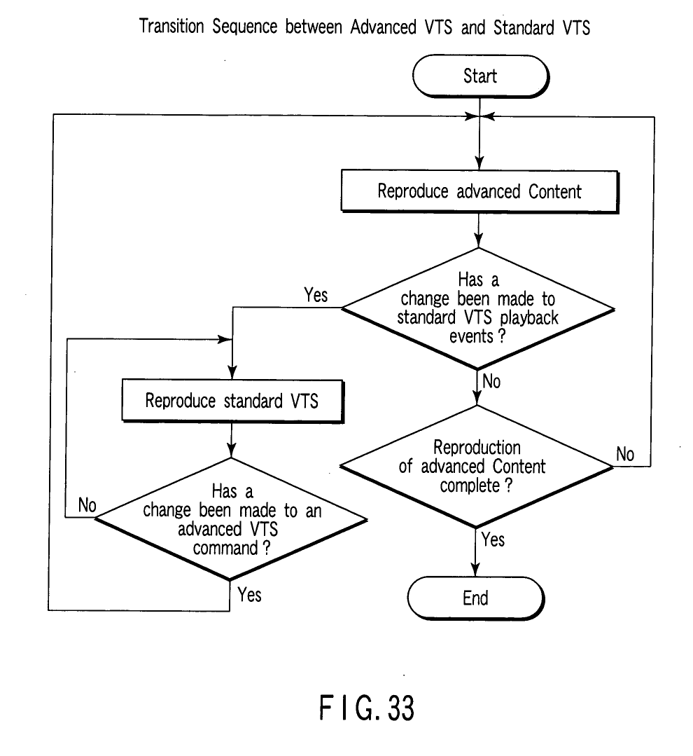

When disc category type 3 is reproduced, playback conversion between advanced VTS and standard VTS is needed. FIG. 33 is a flowchart to help explain the sequence of conversion between advanced VTS and standard VTS.

Playing advanced content:

The playback of a disc of disc category type 3 begins with the playback of an advanced content. In the meantime, a user input event is dealt with by the navigation manager. All of the user events handled by the primary video player have to be transmitted to the primary video player reliably.

Detecting standard VTS playback events:

Using CallStandardContentPlayer API of the advanced navigation, the advanced contentpecifies the conversion of advanced content playback into standard content playback. A playback starting position can be specified in an argument for CallStandardContentPlayer. When detecting a CallStandardContentPlayer command, the navigation manager requests the primary video player to suspend the playback of the advanced VTS and calls up a CallStandardContentPlayer command.

Playing standard VTS:

When the navigation manager has issued CallStandardContentPlayer API, the primary video player jumps from a specified place to the start of standard VTS. In the meantime, the navigation manager is suspended. Therefore, a user event has to be input directly to the primary video player. Moreover, in the meantime, the primary video player carries out all of the playback conversion into standard VTS on the basis of the navigation command.

Detecting advanced VTS playback command:

In standard content, the conversion of standard content playback into advanced content playback is specified by CallAdvancedContnetPlayer of the navigation command. When detecting CallAdvancedContnetPlayer command, the primary video player stops playing the standard VTS and starts the navigation manager again from the execution position immediately after CallAdvancedContnetPlayer command has been called up.

As described above, playback can be switched between advanced content and standard content. In this case, the apparatus of the present invention can display in what state the present playback is.

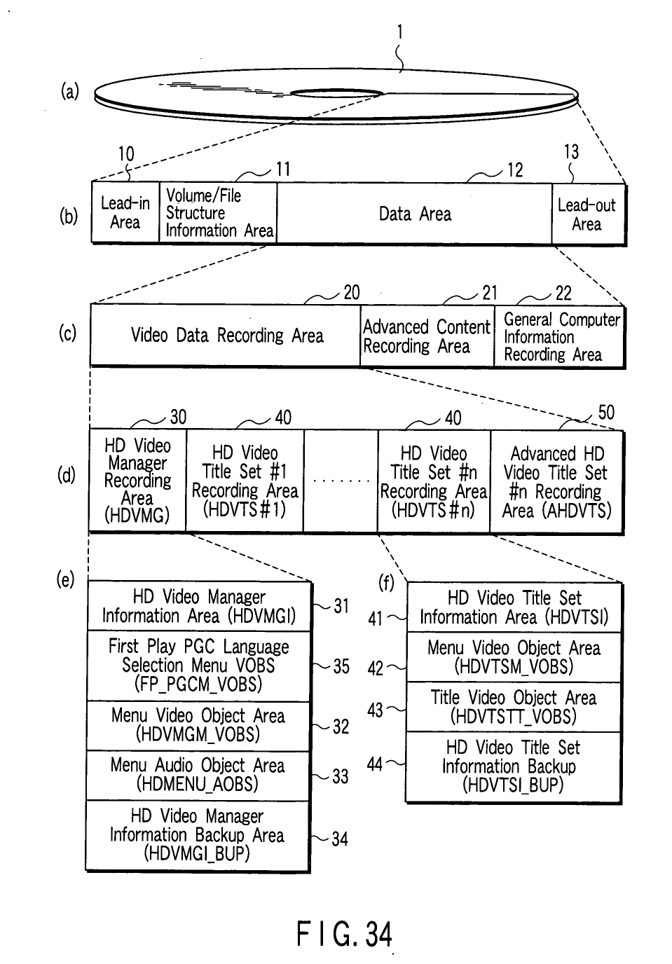

FIG. 34 is a diagram to help explain the content of information recorded on a disc-like information storage medium according to an embodiment of the present invention. An information storage medium 1 shown in FIG. 34(a) may be composed of a high-density optical disc (or high-definition digital versatile disc, abbreviated as HD_DVD) using, for example, red laser with a wavelength of 650 nm or blue laser with a wavelength of 450 nm (or less).

As shown in FIG. 34(b), the information storage medium 1 includes a lead-in area 10, a data area 12, and a lead-out area 13 in that order, starting from the inner edge. The information storage medium 1 employs IS09660 and a UDF bridge structure for the file system and has an IS09660 and UDF volume/file structure information area 11 on the lead-in side of the data area 12.

As shown in FIG. 34(c), a video data recording area 20 in which DVD video content (also referred to as standard content or SD content) are to be recorded, another video data recording area (or an advanced content recording area for recording advanced content) 21, and a general computer information recording area 22 are allowed to be arranged in a mixed manner. (Here, the plural expression content includes the singular expression content. Moreover, the word content also serves as a representative singular form of content.)

As shown in FIG. 34(d), the video data recording area 20 includes an HD video manager (HDVMG: High-Definition Video Manager) recording area 30 in which management information about all of the HD_DVD video content recorded in the video data recording area 20 is recorded, an HD video title set (HDVTS: High-Definition Video Title Set, also referred to as standard VTS) recording area 40 which is organized by title and in which management information and video information (or video objects) are sorted out by title and recorded, and an advanced HD video title set (AHDVTS: also referred to as advanced VTS) recording area 50.

As shown in FIG. 34(e), the HD video manage (HDVMG) includes an HD video manager information (HDVMGI: High-Definition Video Manager Information) area 31 which shows management information related to all of the video data recording area 20, an HD video manager information backup (HDVMGI_BUP) area 34 in which information identical with that in the HD video manager information area 31 is recorded for backup, and a menu video object (HDVMGM_VOBS) area 32 in which a top menu screen showing all of the video data recording area 20 is recorded.

In the embodiment of the present invention, the HD video manager recording area 30 further includes a menu audio object (HDMENU_AOBS) area 33 in which audio information to be output in parallel with a menu display is recorded. Moreover, in the embodiment, a screen which enables menu description language code and the like to be set is configured to be recordable in the area of a first play PGC language selection menu VOBS (FP_PGCM_VOBS) 35 to be executed in the first access immediately after the disc (information storage medium) 1 is installed in the disc drive.

An HD video title set (HDVTS) recording area 40 in which management information and video information (video objects) are sorted out by title and recorded includes an HD video title set information (HDVTSI) area 41 in which management information about all of the content in the HD video title set recording area 40, an HD video title set information backup (HDVTSI_BUP) area 44 in which information identical with that in the HD video title set information area 41 has been recorded as backup data, a menu video object area (HDVTSM_VOBS) 42 in which information on a menu screen has been recorded in video title sets, and a title video object (HDVTSTT_VOBS) area 43 in which video object data (video information on titles) in the video title set has been recorded.

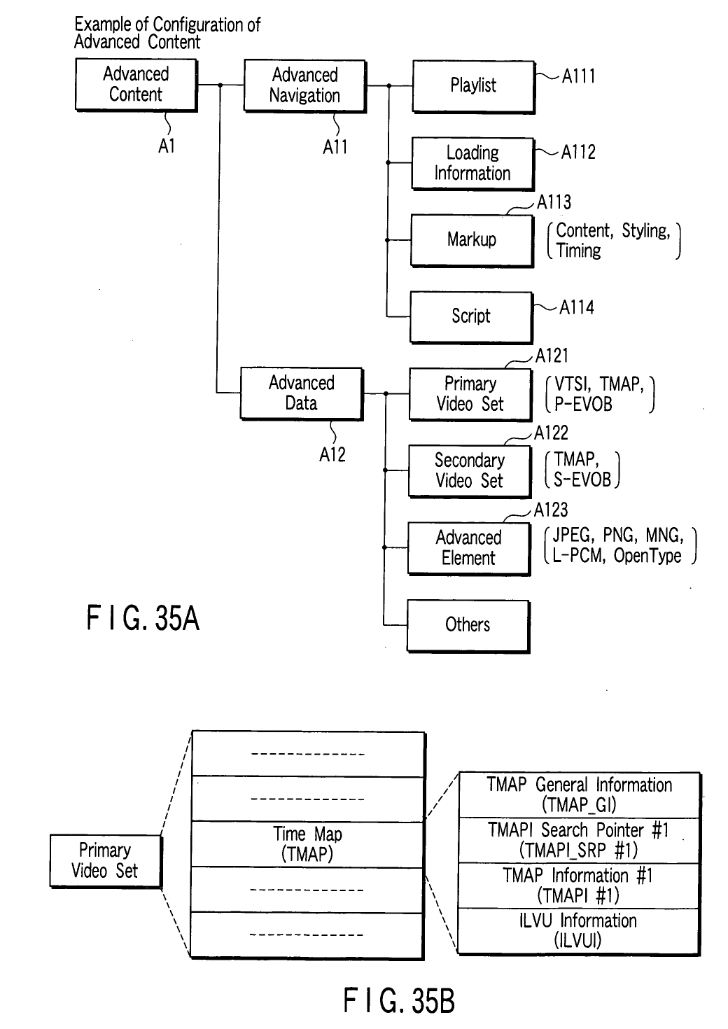

FIG. 35 is a diagram to help explain a configuration of advanced content stored in the advanced content recording area 21 of the information storage medium of FIG. 34. The advanced content is not necessarily stored in an information storage medium and may be supplied from, for example, a server via a network.

As shown in FIG. 35A, advanced content recorded in an advanced content area Al includes advanced navigation which manages primary/secondary video set output and text/graphic rendering and audio output, and advance data composed of data managed by the advanced navigation. The advanced navigation recorded in the advanced navigation area All includes playlist files, loading information files, markup files (for contenttyling, timing information), and script files. The playlist files are recorded in a playlist file area A111. The loading information files are recorded in a loading information file area A112. The markup files are recorded in a markup file area A113. The script files are recorded in a script file area A114.

The advanced data recorded in an advanced data area A12 includes primary video sets including object data (VTSI, TMAP and P-EVOB), secondary video sets including object data (TMAP and S-EVOB), advanced elements (JPEG, PNG, MNG, L-PCM, OpenType font, and the like), and others. In addition to these, the advanced data further includes object data constituting a menu (screen). For example, the object data included in the advanced data is reproduced in a specified period on the timeline according to the time map (TMAP) in the format shown in FIG. 35B. The primary video sets are recorded in a primary video set area A121. The secondary video sets are recorded in a secondary video set area A122. The advanced elements are recorded in an advanced element area A123.

The advanced navigation includes playlist files, loading information files, markup files (for contenttyling, timing information), and script files. These files (playlist files, loading information files, markup files, and script files) are encoded as XML documents. If the resources of XML documents for advanced navigation have not been written in the correct format, they are rejected at the advanced navigation engine.

The XML documents become effective according to the definition of a reference document type. The advanced navigation engine (on the player side) does not necessarily require the function of determining the validity of content (the provider should guarantee the validity of content). If the resources of XML documents have not been written in the correct format, the proper operation of the advanced navigation engine is not guaranteed.

The following rules are applied to XML declaration:
Let encode declaration be “UTF-8” or “ISO-8859-1.” XML files are encoded on the basis of one of these.
Let the value of standard document declaration in XML declaration be set as “no” when the standard document declaration is present. If there is no standard document declaration, the value is regarded as “no.”

All of the resources usable on a disc or a network have addresses encoded by Uniform Resource Identifier defined in [URI, REF2396].

The protocol and path supported for a DVD disc are as follows: for example,

file://dvdrom://dvd_advnav/file.xml

FIG. 35B shows a configuration of the time map (TMAP). As a component part, the time map has time map information (TMAPI) used to convert the playback time in a primary enhanced video object (P-EVOB) into the address of the corresponding enhanced video object unit (EVOBU). In TMAP, TMAP General Information (TMAP_GI), TMAPI Search Pointer (TMAPI_SRP), TMAP Information (TMAPI), and ILVU Information (ILVUI) are arranged in that order.

<About Playlist File>

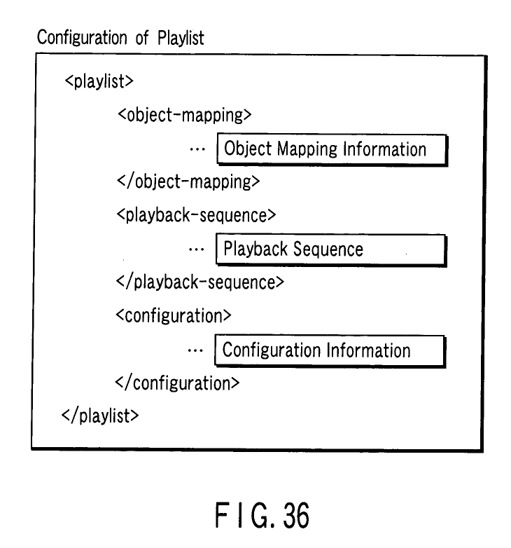

In a playlist file, information about the initial system configuration of the HD-DVD player and advanced content titles can be written. As shown in FIG. 36, in the playlist file, a set of object mapping information and the playback sequence for each title are written for each title. The playlist file is encoded in the XML format. The syntax of the playlist file can be defined by an XML syntax representation.

On the basis of a time map for reproducing a plurality of objects in a specified period on the timeline, the playlist file controls the playback of menus and titles composed of these objects. The playlist enables the menus to be played back dynamically.

Menus unlinked with the time map can give only static information to the user. For example, on the menu, a plurality of thumbnails representative of the individual chapters constituting a title are sometimes attached. For example, when a desired thumbnail is selected via the menu, the playback of the chapter to which the selected thumbnail belongs is started. The thumbnails of the individual chapters constituting a title with many similar scenes represent similar images. This causes a problem: it is difficult to find the desired chapter from a plurality of thumbnails displayed on the menu.

However, with the menu linked with the time map, it is possible to give the user dynamic information. For example, on the menu liked with the time map, a reduced-size playback screen (moving image) for each chapter constituting a title can be displayed. This makes it relatively easy to distinguish the individual chapters constituting a title with many similar scenes. That is, the menu linked with the time map enables a multilateral display, which makes it possible to realize a complex, impressive menu display.

<Elements and Attributes>

A playlist element is a root element of the playlist. An XML syntax representation of a playlist element is, for example, as follows:

<Playlist>
Configuration TitleSet
</Playlist>

A playlist element is composed of a TitleSet element for a set of information on Titles and a Configuraton element for System Configuration Information. The configuration element is composed of a set of System Configuration for Advanced Contentystem Configuration Information may be composed of, for example, Data Cache configuration specifying a stream buffer size and the like.

A title set element is for describing information on a set of Titles for Advanced Content in the playlist. An XML syntax representation of the title set element is, for example, as follows:

<TitleSet>
Title*
</TitleSet>

A title set element is composed of a list of Title elements. Advanced navigation title numbers are allocated sequentially in the order of documents in the title element, beginning at “1.” The title element is configured to describe information on each title.

Specifically, the title element describes information about a title for advanced content which includes object mapping information and a playback sequence in the title. An XML syntax representation of the title element is, for example, as follows:

```
<Title
    id = ID
    hidden = (true | false)
    onExit = positiveInteger>
        Primary Video Track?
        SecondaryVideoTrack ?
        SubstituteAudioTrack ?
        ComplementarySubtitleTrack ?
        ApplicationTrack *
        Chapter List ?
</Title>
```

The content of a title element is composed of an element fragment for tracks and a chapter list element. The element fragment for tracks is composed of a list of elements of a primary video track, a secondary video track, a SubstituteAudio track, a complementary subtitle track, and an application track.

Object mapping information for a title is written using an element fragment for tracks. The mapping of presentation objects on the title timeline is written using the corresponding element. Here, a primary video set corresponds to a primary video track, a secondary video set corresponds to a secondary video track, a SubstituteAudio corresponds to a SubstituteAudio Track, a complementary subtitle corresponds to a complementary subtitle track, and ADV_APP corresponds to an application track.

The title timeline is allocated to each title. Information on a playback sequence for a title composed of chapter points is written using chapter list elements.

Here, (a) hidden attribute makes it possible to write whether the title can be navigated by the user operation. If its value is “true,” the title cannot be navigated by the user operation. The value may be omitted. In that case, the default value is “false.”

Furthermore, (b) on Exit attribute makes it possible to write a title to be reproduced after the playback of the present title. When the playback of the present title is earlier than the ending of the title, the player can be configured not-to jump the playback.

A primary video track element is for describing object mapping information on the primary video set in the title. An XML syntax representation of the primary video track element is, for example, as follows:

```
<Primary Video Track
    id = ID>
        (Clip | Clip Block) +
</Primary Video Track>
```

The content of a primary video track is composed of a list of clip elements and clip block elements which refer to P-EVOB in the primary video as presentation objects. The player is configured to preassign P-EVOBs onto the title timeline using a start time and an end time according to the description of the clip element. The P-EVOBs allocated onto the title timeline are prevented from overlapping with one another.

A secondary video track element is for describing object mapping information on the secondary video set in the title. An XML syntax representation of the secondary video track element is, for example, as follows:

```
<SecondaryVideoTrack
    id = ID
    sync = (true | false)>
        Clip +
</SecondaryVideoTrack>
```

The content of a secondary video track is composed of a list of clip elements which refer to S-EVOB in the secondary video set as presentation objects. The player is configured to preassign S-EVOBs onto the title timeline using a start time and an end time according to the description of the clip element.

Furthermore, the player is configured to map clips and clip blocks onto the title timeline as a start and an end position of the clip on the title timeline on the basis of the title begin time and title end time attribute of the clip element. The S-EVOBs allocated onto the title timeline are prevented from overlapping with one another.

Here, if a sync attribute is “true,” the secondary set is synchronized with time on the title timeline. If a sync attribute is “false,” the secondary video set can be configured to run on its own time (in other words, if the sync attribute is “false,” playback progresses at the time allocated to the secondary video set itself, not at the time on the timeline).

Furthermore, if the sync attribute value is “true” or omitted, the presentation object in the secondary video track becomes a synchronized object. If the sync attribute value is “false,” the presentation object in the SecondaryVideoTrack becomes an unsynchronized object.

A SubstituteAudioTrack element is for describing object mapping information of a substitute audio track in the title and the assignment of audio stream numbers. An XML syntax representation of the substitute audio track element is, for example, as follows:

```
<SubstituteAudioTrack
    id = ID
    streamNumber = Number
        languageCode = token
        >
      Clip +
</SubstituteAudioTrack>
```

The content of a SubstituteAudioTrack element is composed of a list of clip elements which refer to SubstituteAudio as a presentation element. The player is configured to preassign SubstituteAudio onto the title timeline according to the description of the clip element. The SubstituteAudios allocated onto the title timeline are prevented from overlapping with one another

A specific audio stream number is allocated to SubstituteAudio. If Audio_stream_Change API selects a specific stream number of SubstituteAudio, the player is configured to select SubstituteAudio in place of the audio stream in the primary video set.

In a stream number attribute, the audio stream number for SubstituteAudio is written.

In a language code attribute, a specific code for SubstituteAudio and a specific code extension are written.

A language code attribute value follows the following scheme (BNF scheme). Specifically, in the specific code and specific code extension, a specific code and a specific code extension are written respectively. For example, they are as follows:
languagecode :=specificCode ‘:’ specificCodeExtension
specificCode :=[A-Za-z] [A-Za-z0-9]
specificCodeExt :=[0-9A-F] [0-9A-F]

A complementary subtitle track element is for describing object mapping information on a complementary subtitle in the title and the assignment of sub-picture stream numbers). An XML syntax representation of the complementary subtitle track element is, for example, as follows:

```
<ComplementarySubtitleTrack
    id = ID
    streamNumber = Number
        languageCode = token
        >
      Clip +
</ComplementarySubtitleTrack>
```

The content of a complementary subtitle element is composed of a list of clip elements which refer to a complementary subtitle as a presentation element. The player is configured to preassign complementary subtitles onto the title timeline according to the description of the clip element. The complementary subtitles allocated onto the title timeline are prevented from overlapping with one another

A specific sub-picture stream number is allocated to the complementary subtitle. If Sub-picture_stream_Change API selects a stream number for the complementary subtitle, the player is configured to select a complementary subtitle in place of the sub-picture stream in the primary video set.

In a stream number attribute, the sub-picture stream number for the complementary subtitle is written.

In a language code attribute, a specific code for the complementary subtitle and a specific extension are written.

A language code attribute value follows the following scheme (BNF scheme). Specifically, in the specific code and specific code extension, a specific code and a specific code extension are written respectively. For example, they are as follows:

```
<ComplementarySubtitleTrack
    id = ID
    streamNumber = Number
        languaqeCode = token
        >
      Clip +
</ComplementarySubtitleTrack>
```

An application track element is for describing object mapping information on ADV_APP in the title. An XML syntax representation of the application track element is, for example, as follows:

```
<ApplicationTrack
    id = ID
    loading_info = anyURI
    sync = (true | false)
    language = string />
```

Here, ADV_APP is scheduled on the entire title timeline. When starting the playback of the title, the player starts ADV_APP on the basis of loading information shown by the loading information attribute. If the player stops the playback of the title, ADV_APP in the title is also terminated.

Here, if the sync attribute is “true,” ADV_APP is configured to be synchronized with time on the title timeline. If the sync attribute is “false,” ADV_APP can be configured to run at its own time.

Loading information attribute is for describing URI for a loading information file in which initialization information on the application has been written.

If the sync attribute value is “true,” this means that ADV_APP in ApplicationTrack is a synchronized object. If the sync attribute value is “false,” this means that ADV_APP in ApplicationTrack is an unsynchronized object.

A clip element is for describing information on the period (the life period or the period from the start time to end time) on the title timeline of the presentation object. An XML syntax representation of the clip element is, for example, as follows:

```
    <Clip
        id = ID
        title Time Begin = time Expression
        clip Time Begin = time Expression
        title Time End = time Expression
        src = anyURI
        preload = time Expression
        xml:base = anyURI >
            (Unavailable Audio Stream |
Unavailable Sub picture Stream )*
        </Clip>
```

The life period on the title timeline of the presentation object is determined by the start time and end time on the title timeline. The start time and end time on the title timeline can be written using a title Time Begin attribute and a title Time End attribute. The starting position of the presentation object is written using a clip Time Begin attribute. At the start time on the title timeline, the presentation object is in the start position written using a clip Time Begin.

The presentation object is referred to using URI of the index information file. For a primary video set, the P-EVOB TMAP file is referred to. For a secondary video object, the S-EVOB TMAP file is referred to. For SubstituteAudios and complementary subtitles, the S-EVOB TMAP file in the secondary video set including objects is referred to.

The attribute values of title Begin Time, title End Time, clip Begin Time, and presentation object duration are configured to satisfy the following relationship:

```
    title Begin Time < title End Time, and
    Clip Begin Time + title End Time − title
Begin Time
        ≦ Presentation Object in duration
time
```

Unavailable audio streams and unavailable sub-picture streams are present only for the clip elements in a preliminary video track element.

A title Time Begin attribute is for describing a start time of a continuous fragment of a presentation object on the title timeline.

A title Time End attribute is for describing an end time of the continuous fragment of the presentation object on the title timeline.

A clip Time Begin attribute is for describing a starting position in the presentation object. Its value can be written in the time Expression value. The clip Time Begin may be omitted. If there is no clip Time Begin attribute, let the starting position be, for example, “0.”

An src attribute is for describing URI of an index information file of presentation objects to be referred to.

A preload attribute is for describing time on the title timeline in staring the reproduction of a presentation object fetched in advance by the player.

A clip block element is for describing a group of clips in P-EVOBS called a clip block. One clip is selected for playback. An XML syntax representation of a clip block element is, for example, as follows:

<Clip Block>
Clip+
</Clip Block>

All of the clips in the clip block are configured to have the same start time and the same end time. For this reason, the clip block can do scheduling on the title timeline using the start time and end time of the first child clip. The clip block can be configured to be usable only in a primary video track.

The clip block can represent an angle block. In the order of documents in the clip element, advanced navigation angle numbers are allocated consecutively, beginning at “1.”

The player selects the first clip to be reproduced as a default. However, if Angle_Change API has selected a specific angle number, the player selects a clip corresponding to it as the one to be reproduced.

The unavailable audio stream elements in a clip element that describes a decoding audio stream in P-EVOBS is configured to be unavailable during the reproducion of the clip. An XML syntax representation of an unavailable audio stream element is, for example, as follows:

```
<Unavailable Audio Stream
    number = integer
    />
```

An unavailable audio stream element can be used only in a P-EVOB clip element in the primary video track element. Otherwise, any unavailable audio stream is caused to be absent. The player disables the decoding audio stream shown by the number attribute.

An unavailable sub-picture stream element in a clip element that describes a decoding sub-picture stream in P-EVOBS is configured to be unavailable during the reproduction of the clip. An XML syntax representation of an unavailable sub-picture stream element is, for example, as follows:

```
<Unavailable Sub picture Stream
    number = integer
    />
```

An unavailable sub-picture stream element can be used only in P-EVOB clip elements in the primary video track element. Otherwise, any unavailable sub-picture stream is caused to be absent. The player disables the decoding sub-picture stream shown by the number attribute.

A chapter list element in the title element is for describing playback sequence information for the title. The playback sequence defines the chapter start position using a time value on the title timeline. An XML syntax representation of a chapter list element is, for example, as follows:

<Chapter List>
Chapter+
</Chapter List>

A chapter list element is composed of a list of chapter elements. A chapter element describes the chapter start position on the title timeline. In the order of documents in a chapter element in the chapter list, the advanced navigation chapter numbers are allocated consecutively, beginning at “1.” Specifically, the chapter positions on the title timeline are configured to monotonically increase according to the chapter numbers

A chapter element is for describing the chapter start position on the title timeline in the playback sequence. An XML syntax representation of a chapter element is, for example, as follows:

```
    <Chapter
        id = ID
        title Begin Time = time
Expression />
```

A chapter element has a title Begin Time attribute. The time Expression value of the title Begin Time attribute is for describing the chapter start position on the title timeline.

The title Begin Time attribute is for describing the chapter start position on the title timeline in the playback sequence. Its value is written in the time Expression value.

<Datatypes>

time Expression is for describing time code in integers in units of, for example, 90 kHz.

[About loading information files]

A loading information file is for title ADV_APP initial information. The player is configured to start ADV_APP on the basis of the information in the loading information file. The ADV_APP has a configuration composed of the presentation of Markup file and the execution of Script.

Pieces of initial information written in the loading information file are as follows:
Files to be stored in the file cache first before the execution of an initial markup file
Initial markup file to be executed
Script file to be executed

A loading information file has to be encoded in the correct XML form. The rules for XML document files are applied to the loading information file.

<Elements and Attributes>

The syntax of a loading information file is determined using an XML syntax representation.

An application element is the root element of a loading information file and includes the following elements and attributes:

XML syntax representation of an application element:

```
    <Application
        Id = ID
        >
            Resource* Script ? Markup ?
Boundary ?
    </Application>
```

A resource element is for describing files to be stored in the file cache before the execution of the initial markup. An XML syntax representation of a playlist element is, for example, as follows:

```
<Resource
    id = ID
    src = anyURI
    />
```

Here, the src attribute is for describing URI of a file stored in the file cache.

A script element is for describing an initial script file for ADV_APP. An XML syntax representation of a script element is, for example, as follows:

```
<Script
    id = ID
    src = anyURI
    />
```

At the start-up of an application, the script engine loads a script file to be referred to using URI in the scr attribute and executes the loaded file as global code [ECMA 10.2.10]. The src attribute describes URI for initial script files.

A markup element is for describing an initial markup file for ADV_APP. An XML syntax representation of a markup element is, for example, as follows:

```
<Markup
    id = ID
    src = anyURI
    />
```

At the start-up of an application, if there is an initial script file, the advanced navigation refers to URI in the src attribute after the execution of the initial script file, thereby loading a markup file. Here, the src attribute describes URI for the initial markup file.

A boundary element can be configured to describe effective URL to which an application can refer.

<About Markup Files>

A markup file is information on presentation objects on the graphic plane. The number of markup files which can exist at the same time in an application is limited to one. A markup file is composed of a content model, styling, and timing.

<About Script Files>

A script file is for describing script global codes. The script engine is configured to execute a script file at the start-up of ADV_APP and wait for an event in an event handler defined by the executed script global code.

Here, the script is configured to be capable of controlling the playback sequence and graphics on the graphics plane according to an event, such as a user input event or a player playback event.

<Playlist File: written in XML (markup language)>

A reproducing unit (or player) is configured to reproduce the palylist file first (before reproducing advanced content), when the disc has advanced content.

The playlist file can contain the following information:
Object mapping information (information on presentation objects mapped on the timeline in each title)
Playback sequence (playback information for each title written by the timeline of the title)
Configuration information (information for system configuration, such as data buffer alignment)

The primary video set is composed of Video Title Set Information (VTSI), Enhanced Video Object Set for Video Title Set (VTS_EVOBS), Backup of Video Title Set Information (VTSI_BUP), and Video Title Set Time Map Information (VTS_TMAPI).

Several of the following files can be stored in an archive without compression:
Manifest (XML)
Markup (XML)
Script (ECMAScript)
Image (JPEG/PNG/MNG)
Sound effect audio (WAV)
Font (OpenType)
Advanced subtitle (XML)

In this standard, a file stored in the archive is called an advanced stream. The file can be stored (under the ADV_OBJ directory) on a disc or delivered from a server. The file is multiplexed with EVOB in the primary video set. In this case, the file is divided into packs called advanced packs (ADV_PCK).

FIG. 36 is a diagram to help explain an example of the configuration of a playlist. Each of Object Mapping, Playback Sequence, and Configuration is written in such a manner that three areas are specified under a root element.

The file of the playlist can include the following information:
Object mapping information (information in each title which is for presentation objects mapped on the timeline of the title)
Playback sequence (playback information for each title written according to the timeline of the title)
Configuration information (information for system configuration, such as data buffer alignment)

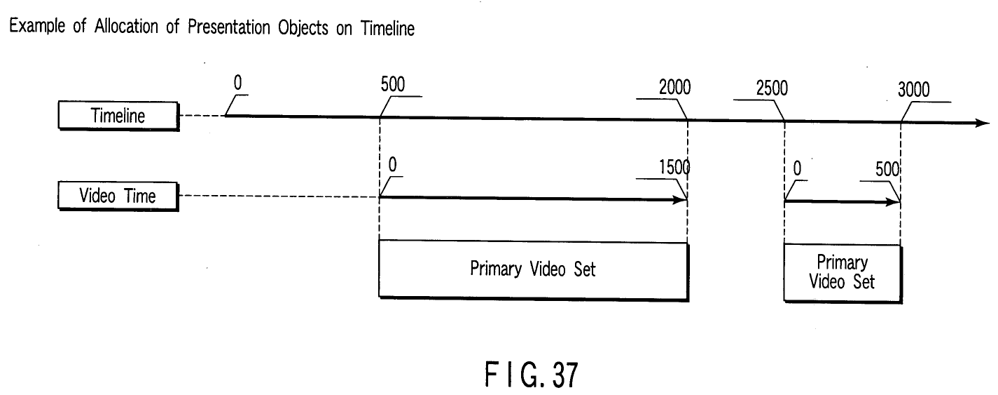

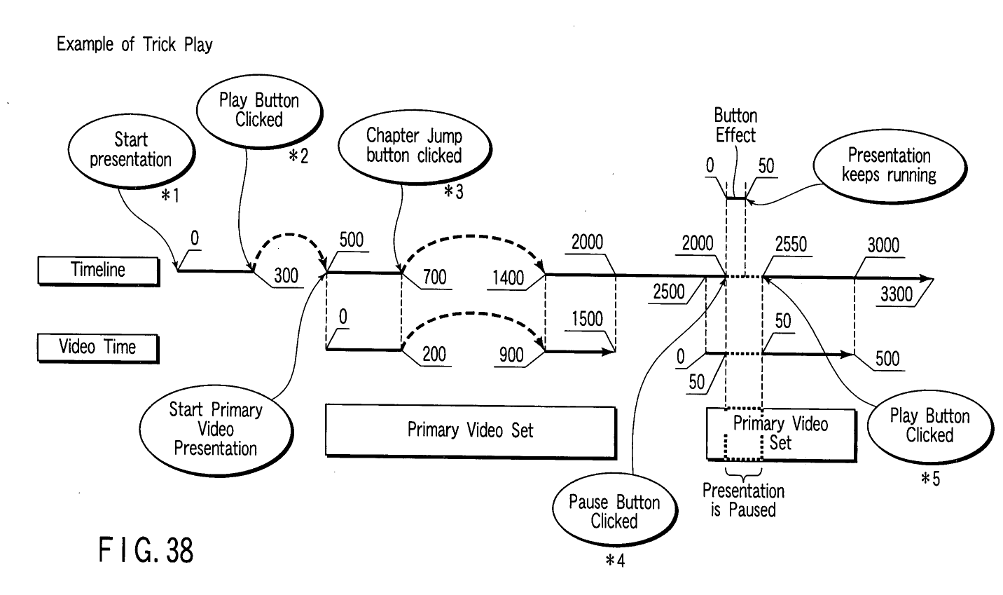

FIGS. 37 and 38 are diagrams to help explain the timeline used in the playlist. FIG. 37 shows an example of the allocation of presentation objects on the timeline. As units of timeline, video frames, seconds (milliseconds), clocks with a base of 90 kHz/27 MHz, units determined in the SMPTE can be used. In the example of FIG. 37, there are prepared two primary video sets with time lengths of 1500 and 500, respectively. They are arranged in the range of 500 to 1500 and in the range of 2500 to 3000 on the timeline serving as a time axis. Objects with their own time lengths are arranged on the timeline, a time axis, which enables each object to be reproduced without contradiction. The timeline can be configured to be reset for each playlist used.

FIG. 38 is a diagram to help explain a case where a trick play (such as a chapter jump) of a presentation object is made on the timeline. FIG. 38 shows an example of the way time advances on the timeline when a playback operation is actually carried out. That is, when the playback operation is started, time starts to advance on the timeline *1. At time “300” on the timeline, if the play button is clicked *2, time on the timeline jumps to “500” and a primary video set starts to be played back. After this, at time “700”, if the chapter jump button is clicked *3, it jumps to the starting position of a corresponding chapter (in this example, time “1400” on the timeline) and the playback operation is started from the position. After this, if the pause button is clicked at time “2550” (by the user of the player) *4, a button effect occurs and then the playback operation is paused. If the play button is clicked at time “2550” *5, the playback operation is started again.

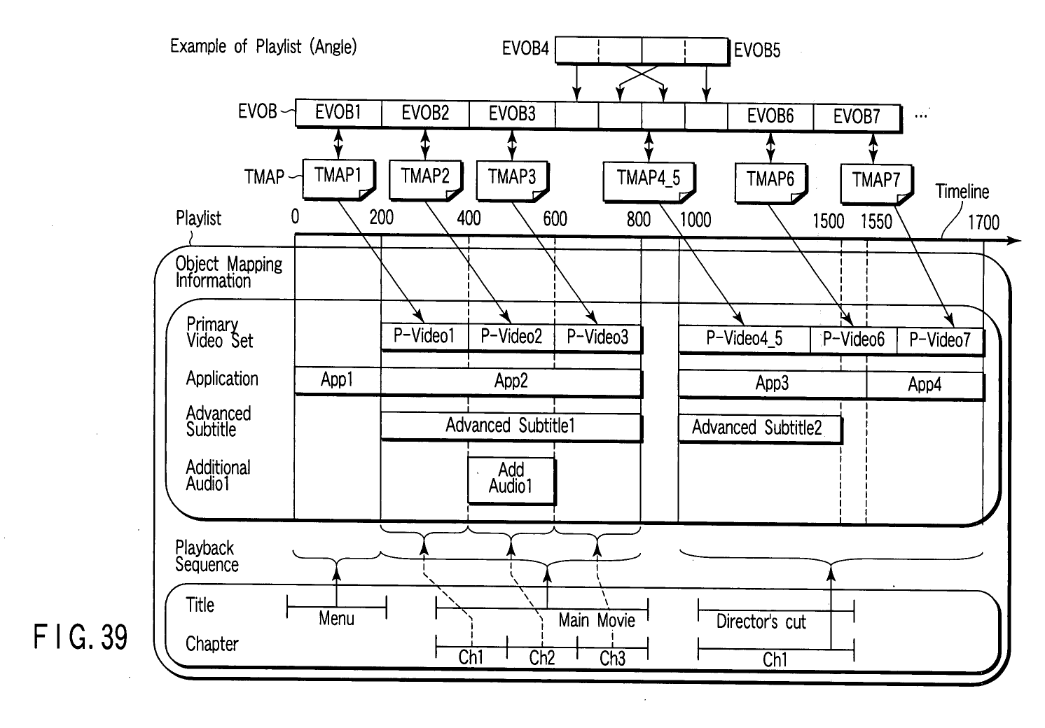

FIG. 39 shows an example of the playlist when EVOB has an interleaved angle. Although EVOB has the corresponding TMAP files, interleaved angle blocks EVOB4 and EVOB5 have information written in the same TMAP file. By specifying the individual TMAP files in the object mapping information, primary video sets are mapped on the timeline. Moreover, according to the description of the object mapping information in the playlist, applications, advanced subtitles, additional audios, and others are mapped on the timeline.

In FIG. 39, a title with no video (such as menu in use) has been defined between time 0 to time 200 on the timeline as application 1. Moreover, in the period between time 200 and time 800, application 2, primary video 1 to 3, advanced subtitle 1, and additional audio 1 have been set. In the period between time 1000 and time 1700, primary video 4_5 composed of EVOB4 and EVOB5 constituting an angle block, primary video 6, primary video 7, applications 3 and 4, and advanced substitute 2 have been set.

Furthermore, in the playback sequence, Appl defines menu as a title, App2 defines main movie as a title, and App3 and App4 define the configuring of director's cut. In addition, three chapters have been defined in main movie and one chapter has been defined in director's cut.

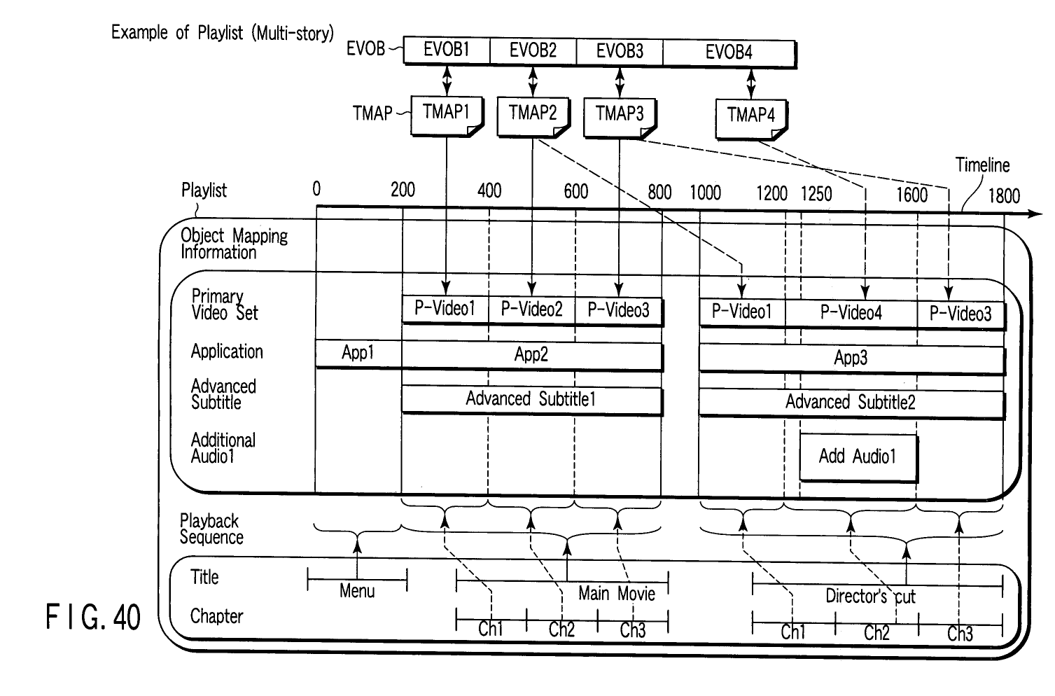

FIG. 40 is a diagram to help explain an example of the configuration of the playlist when an object includes a multi-story. FIG. 40 is a view of the playlist when a multi-story is set. By specifying TMAP in the object mapping information, these two titles are mapped on the timeline. In the example, EVOB1 and EVOB3 are used in both titles and EVOB2 and EVOB4 are replaced with each other, thereby enabling a multi-story.

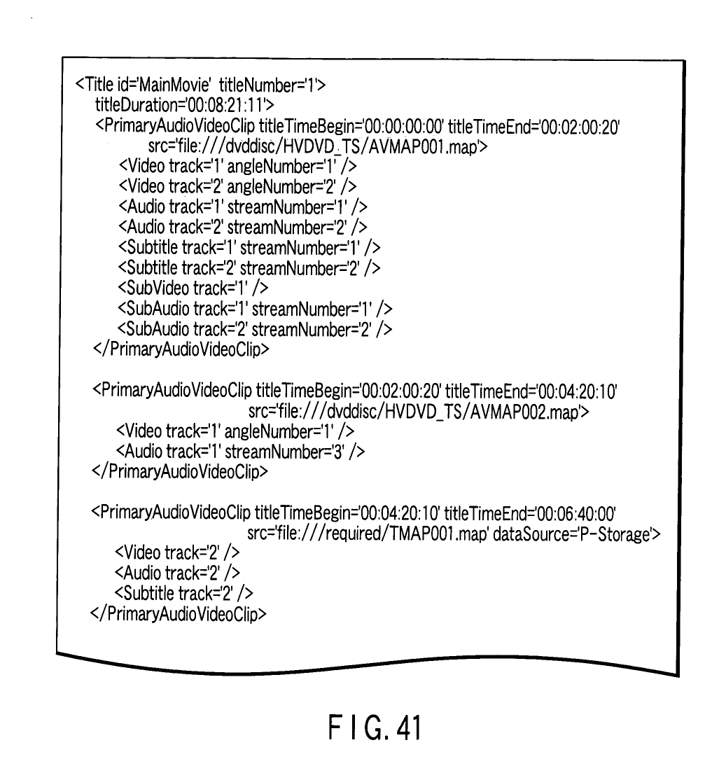

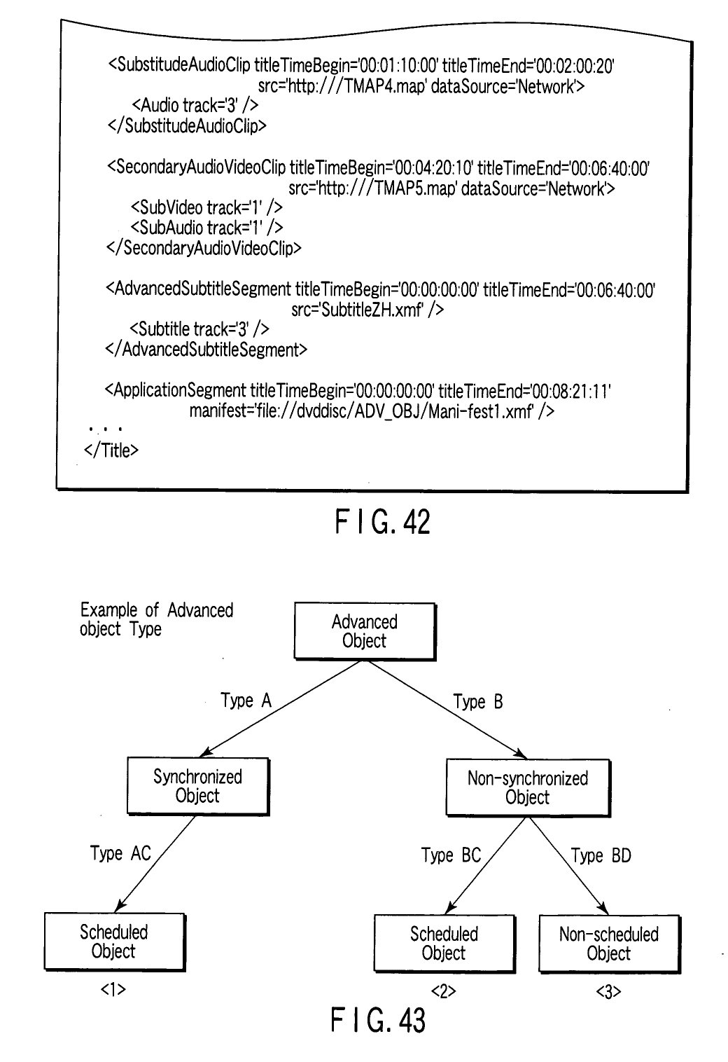

FIGS. 41 and 42 are diagrams to help explain an example of the description of object mapping information in the playlist (when an object includes angle information). Track elements are used in specifying the individual objects. Time on the timeline is expressed using the start and end attributes.

At this time, when applications are arranged consecutively on the timeline as the aforementioned Appl and App2, end attributes may be omitted. When there is a space as between App2 and App3, an end attribute is used to make a representation. Use of the name attribute makes it possible to display a during-playback state on (the display panel of) the player or an external monitor screen. Audio and Subtitle can be distinguished using stream numbers.

FIG. 43 is a diagram to help explain examples (here, four examples) of the advanced object type. The types of advanced objects can be classified into three in FIG. 43. First, classifying is done, depending on whether playback is performed in synchronization with the timeline, or whether playback is performed asynchronously according to its own playback time. In addition, classifying is done, depending on whether playback is started at the playback start time on the timeline recorded in the playlist (in the case of a scheduled object), or whether an arbitrary playback start time is waited for by the user operation (in the case of an unscheduled object).

This invention may be embodied by modifying the component parts variously without departing from the spirit or essential character of the invention, on the basis of available techniques in the present and future embodiment stages. The invention is applicable to a DVD-VR (video recorder) capable of recording and reproducing which has been in increasing demand in recent years. Furthermore, the invention will be applicable to the reproducing system or the recording and reproducing system of the next-generation HD-DVD which will be popularized in near future.

This invention is not limited to the above embodiments. Various inventions may be formed by combining suitably a plurality of component elements disclosed in the embodiments. For example, some components may be removed from all of the component elements constituting the embodiments. Furthermore, component elements used in two or more embodiments may be combined suitably.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information reproducing apparatus comprising:
a navigation manager which manages a playlist used to arbitrarily specify reproducing times of a plurality of independent objects in at least one of a singular form and multiplexed form,
a data access manager which fetches the object corresponding to the reproducing time from an information source at time precedent to the reproducing time specified by the playlist,
a data cache which temporarily stores at least one of a singular object and a plurality of objects fetched by the data access manager according to the order of the reproducing times specified by the playlist and outputs the same in an order corresponding to the reproducing time,
a presentation engine which decodes at least one of a singular object and a plurality of objects output from the data cache by use of a corresponding decoder,
an AV renderer which outputs at least one of a singular object and a plurality of objects output from the presentation engine and decoded in at least one of a singular form and combined form,
a live information analyzer which analyzes the type of at least one of the singular object and the plurality of objects output according to the playlist by the data access manager and data cache, and
a status display data storage section which outputs object identification information corresponding to the object now output according to the analyzing result of the live information analyzer.

2. The information reproducing apparatus according to claim 1, wherein the type of at least one of the singular object and the plurality of objects is main video and sub-video and the status display data storage section outputs identification information indicating that the main video image and sub-video image are output.

3. The information reproducing apparatus according to claim 1, wherein the type of the object contains an application fetched by the navigation manager and the status display data storage section outputs identification information indicating that the application is operated when the application controls the presentation engine and AV renderer.

4. The information reproducing apparatus according to claim 1, wherein the status display data storage section outputs the object identification information to a display device on which video objects are displayed.

5. The information reproducing apparatus according to claim 1, wherein the status display data storage section outputs the object identification information to a display mounted on an apparatus main body.

6. A status display method of an information reproducing apparatus having a navigation manager which manages a playlist used to arbitrarily specify reproducing times of a plurality of independent objects in at least one of a singular form and multiplexed from, a data access manager which fetches the object corresponding to the reproducing time from an information source at time precedent to the reproducing time specified by the playlist, a data cache which temporarily stores at least one of a singular object and a plurality of objects fetched by the data access manager according to the order of the reproducing times specified by the playlist and outputs the same in an order corresponding to the reproducing time, a presentation engine which decodes at least one of a singular object and a plurality of objects output from the data cache by use of a corresponding decoder, and an AV renderer which outputs at least one of a singular object and a plurality of objects output from the presentation engine and decoded in at least one of a singular form and combined form, comprising:
analyzing the type of at least one of the object and a plurality of objects output from the data access manager and data cache according to the playlist, and
outputting object identification information corresponding to the object which is now output based on the analyzing result.

7. The status display method of the information reproducing apparatus according to claim 6, wherein the type of at least one of the singular object and the plurality of objects is main video and sub-video and a status display data storage section outputs identification information indicating that the main video image and sub-video image are output.

8. The status display method of the information reproducing apparatus according to claim 7, wherein the type of the object contains an application fetched by the navigation manager and the status display data storage section outputs identification information indicating that the application is operated when the application controls the presentation engine and AV renderer.

9. The status display method of the information reproducing apparatus according to claim 7, wherein the status display data storage section outputs the object identification information to a display device on which video objects are displayed.

10. The status display method of the information reproducing apparatus according to claim 7, wherein the status display data storage section outputs the object identification information to a display mounted on an apparatus main body.
